(19) United States
(12) Patent Application Publication
(10) Pub. No.: US 2016/0127508 A1
(43) Pub. Date: May 5, 2016

(54) IMAGE PROCESSING APPARATUS, IMAGE PROCESSING SYSTEM, IMAGE PROCESSING METHOD AND STORAGE MEDIUM

(71) Applicant: SQUARE ENIX HOLDINGS CO., LTD., Shinjuku-ku, Tokyo (JP)

(72) Inventor: Cyril PERRIN, ANTONY (FR)

(73) Assignee: SQUARE ENIX HOLDINGS CO., LTD., Tokyo (JP)

(21) Appl. No.: 14/898,834

(22) PCT Filed: Jun. 10, 2014
(86) PCT No.: PCT/JP2014/065827

§ 371 Date: Dec. 16, 2015

Related U.S. Application Data
(60) Provisional application No. 61/835,765, filed on Jun. 17, 2013.

(51) Int. Cl. H04L 29/06; G06T 1/20

(52) U.S. Cl. CPC H04L 67/38; H04L 65/601; G06T 1/20

(57) ABSTRACT

An image processing apparatus acquires a first frame and acquiring additional image data for at least one of a first user or a second user, generates a first composite frame for the first user by combining the first frame and the additional image data for the first user and/or a second composite frame for the second user by combining the first frame and the additional image data for the second user, outputs, for the first user, the first composite frame if the first composite frame is generated or the first frame otherwise, and outputs, for the second user, the second composite frame if the second composite frame is generated or the first frame otherwise.

This application claims the benefit of U.S. Provisional Patent Application No. 61/835,765, filed Jun. 17, 2013, which is hereby incorporated by reference herein in its entirety.

### TECHNICAL FIELD

The present invention relates generally to image processing techniques and, in particular, to an apparatus, a system and a method for generating personalized video data streams for each of a plurality of users.

### BACKGROUND ART

The video game industry has seen considerable evolution, from the introduction of stand-alone arcade games, to home-based computer games, to the emergence of games made for specialized consoles. Widespread public access to the Internet then led to another major development, namely “cloud gaming”. In a cloud gaming system, a player can utilize an ordinary Internet-enabled appliance such as a smartphone or tablet to connect to a video game server over the Internet. The video game server starts a session for the player, and may do so for multiple players. The video game server renders video data and generates audio for the player based on player actions (e.g., moves, selections) and other attributes of the game. Encoded video and audio is delivered to the player's device over the Internet, and is reproduced as visible images and audible sounds. In this way, players from anywhere in the world can play a video game without the use of specialized video game consoles, computationally intensive software or dedicated graphics processing hardware.

In a conventional cloud computing implementation, different images sent to different players over the Internet are produced from different sets of rendering instructions. That is, any per-player customization of the image is done prior to rendering, by modifying the rendering instructions or the resources accessed by those rendering instructions. Consequently, even in a case where only minor per-player modifications are required to what is basically the same image, the traditional approach can add a disproportionately large computational burden to the server. Also, traditional per-player customization may not even be possible when there is no access to the original video game code. Thus, an improvement is needed that addresses one or more of the aforementioned deficiencies.

### SUMMARY OF INVENTION

According to one aspect of the present invention, there is provided an image processing apparatus, comprising acquisition means for acquiring a first frame, which is rendered by rendering means and is included in a video data stream, and acquiring additional image data for at least one of a first user or a second user, combining means for generating a first composite frame for the first user by combining the first frame and the additional image data for the first user and/or a second composite frame for the second user by combining the first frame and the additional image data for the second user, and outputting means for outputting, for the first user, the first composite frame if the first composite frame is generated or the first frame otherwise, and outputting, for the second user, the second composite frame if the second composite frame is generated or the first frame otherwise.

According to one aspect of the present invention, there is provided an image processing apparatus, comprising rendering means for rendering a set of initial frames representing a sequence of images and customization means for receiving customization information for each of a plurality of users and modifying the set of initial frames to produce a plurality of sets of output frames, wherein each set of output frames representing a sequence of images that nave been customized for a respective one of the users based on the customization information for that user.

Further features of the present invention will become apparent from the following description of exemplary embodiments with reference to the attached drawings.

### BRIEF DESCRIPTION OF DRAWINGS

In the accompanying drawings:

FIG. 1A is a block diagram of a cloud-based video game system architecture including a server system, according to a non-limiting embodiment of the present invention.

FIG. 1B is a block diagram of the cloud-based video game system architecture of FIG. 1A, showing interaction with the set of client devices over the data network during game play, according to a non-limiting embodiment of the present invention.

FIG. 2A is a block diagram showing various physical components of the architecture of FIG. 1, according to a non-limiting embodiment of the present invention.

FIG. 2B is a variant of FIG. 2A.

FIG. 2C is a block diagram snowing various modules of the server system in the architecture of FIG. 1, which can be implemented by the physical components of FIG. 2A or 2B and which may be operational during game play.

FIGS. 3A to 3C are flowcharts showing execution of a set of video game processes carried out by a rendering command generator, in accordance with non-limiting embodiments of the present invention.

FIGS. 4A and 4B are flowcharts showing operation of a client device to process received video and audio, respectively, in accordance with non-limiting embodiments of the present invention.

FIG. 5A is a block diagram showing a rendering unit in accordance with a first non-limiting embodiment of the present invention.

FIG. 5B depicts creation, by the rendering unit of FIG. 5A, of a composite frame from a primary frame and an auxiliary frame.

FIG. 6A is a block diagram showing a rendering unit in accordance with a second non-limiting embodiment of the present invention.

FIG. 6B depicts creation, by the rendering unit of FIG. 6A, of a composite frame from a primary frame and an auxiliary frame.

FIG. 7 is a block diagram showing a rendering unit in accordance with a third non-limiting embodiment of the present invention.

FIG. 8 is a block diagram showing a rendering unit in accordance with a fourth non-limiting embodiment of the present invention.

FIG. 9 is a block diagram showing a rendering unit in accordance with a fifth non-limiting embodiment of the present invention.

FIG. 10 conceptually illustrates how various elements of the rendering unit may be implemented in a rendering server and/or in a compute server.

FIG. 11 is a block diagram of a rendering unit in its immediate operating environment.

FIG. 12 shows a client device in accordance with a non-limiting embodiment of the present invention.

It is to be expressly understood that the description and drawings are only for the purpose of illustration of certain embodiments of the invention and are an aid for understanding. They are not intended to be a definition of the limits of the invention.

### DESCRIPTION OF EMBODIMENTS

Cloud-Based System Architecture

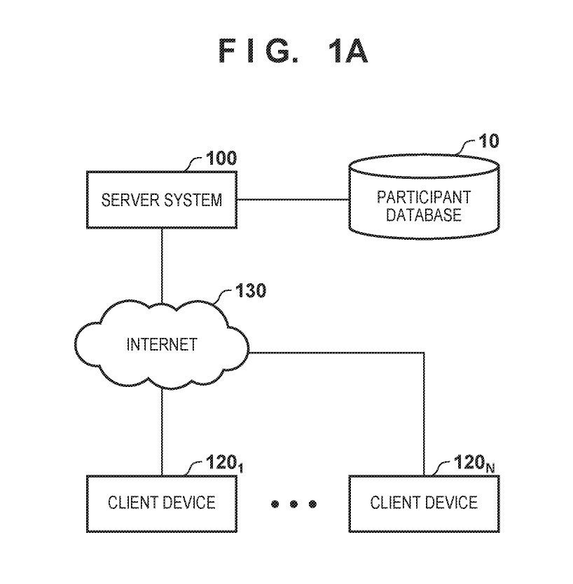

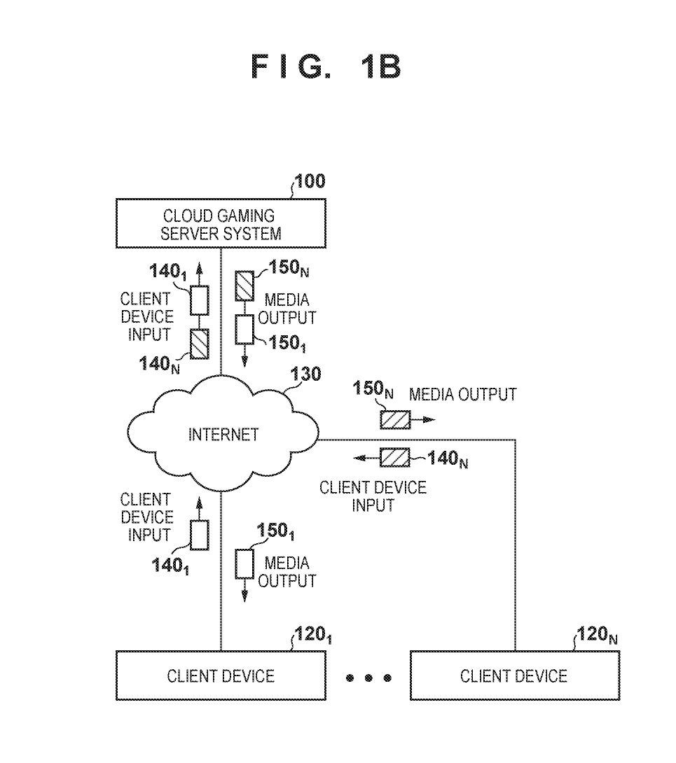

FIG. 1A schematically shows a cloud-based system architecture according to a non-limiting embodiment of the present invention. The architecture may include client devices 120ₙ (where 1≦n≦N and where N represents the number of users participating in the video game) connected to an information processing apparatus, such as a server system 100, over a data network such as the Internet 130. It should be appreciated that N, the number of client devices in the cloud-based system architecture, is not particularly limited.

The server system 100 provides a virtual space in which a plurality of client device users can simultaneously participate. In some cases, this virtual space may represent a video game, while in other cases it may provide a visual effect that is used as a tool for supporting communication or improving user experiences for communication. Each user can operate and move within the space a corresponding avatar which is positioned in the virtual space. When a user operates an avatar in the virtual space, a screen for a viewpoint set in the space is provided to the client device of the user. The viewpoint may be selected from among preset fixed viewpoints, or may be selectively changeable by the user, or be something that is changed in accordance with movement (rotation) operation on the avatar by the user.

The configuration of the client devices 120ₙ (1≦n≦N) is not particularly limited. In some embodiments, one or more of the client devices 120ₙ (1≦n≦N) may be embodied in a personal computer (PC), a home game machine (console), a portable game machine, a smart television, a set-top box (STB), etc. In other embodiments, one or more of the client devices 120ₙ (1≦n≦N) may be a communication or computing device such as a mobile phone, a personal digital assistant (PDA), or a tablet.

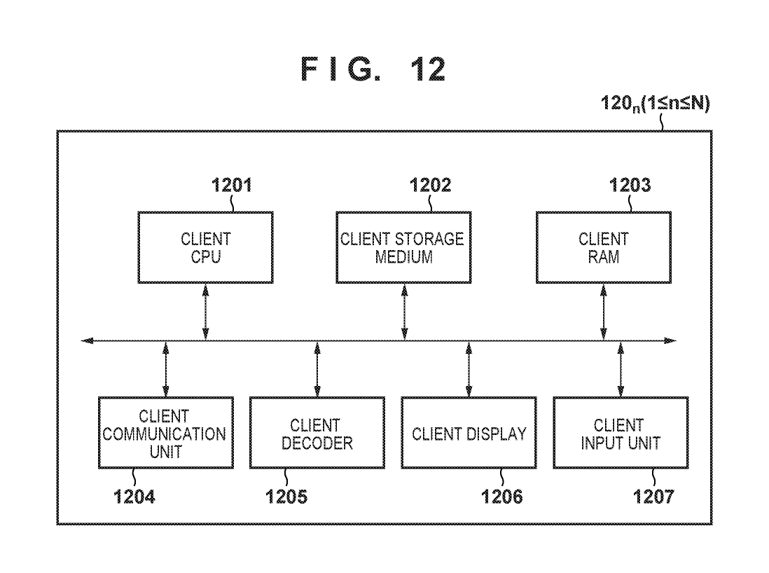

FIG. 12 shows a general configuration of an example client device 120ₙ (1≦n≦N) in accordance with a non-limiting embodiment of the present invention. A client CPU 1201 may control operation of blocks/modules comprised in the client device 120ₙ. The client CPU 1201 may control operation of the blocks by reading out operation programs for the blocks stored in a client storage medium 1202, loading them into a client RAM 1203 and executing them. The client storage medium 1202 may be an HDD, a non-volatile ROM, or the like. Also, operation programs may be dedicated applications, browsing applications or the like. In addition to being a program loading area, the client RAM 1203 and may also be used as a storage area for temporarily storing such things as intermediate data output in the operation of any of the blocks.

A client communication unit 1204 may be a communication interface comprised in the client device 120ₙ. In an embodiment, the client communication unit 1204 may receive encoded screen data of the provided service from the information processing apparatus (server system 100) via the Internet 130. Also, in the reverse direction of communication, the client communication unit 1204 may transmit information regarding operation inputs made by the user of the client device 120ₙ via the Internet 130 to the information processing apparatus (server system 100). A client decoder 1205 may decode encoded screen data received by the client communication unit 1204 and generate screen data. The generated screen data is presented to the user of the client device 120ₙ by being output to a client display 1206 and displayed. Note that it is not necessary that the client device have the client display 1206, and the client display 1206 may be an external display apparatus connected to the client device.

A client input unit 1207 may be a user interface comprised in the client device 120ₙ. The client input unit 1207 may include input devices (such as a touch screen, a keyboard, a game controller, a joystick, etc.), and detect operation input by the user. For the detected operation input, integrated data may be transmitted via the client communication unit 1204 to the server system 100, and may be transmitted as information indicating that a particular operation input was performed after analyzing the operation content. Also, the client input unit 1207 may include other sensors (e.g., Kinect™) that may include a camera or the like, that detect as operation input a motion of a particular object, or a body motion made by the user. In addition, the client device 120ₙ may include a loudspeaker for outputting audio.

Returning now to FIG. 1A, each of the client devices 120ₙ (1≦n≦N) may connect to the Internet 130 in any suitable manner, including over a respective local access network (not shown). The server system 100 may also connect to the Internet 130 over a local access network (not shown), although the server system 100 may connect directly to the Internet 130 without the intermediary of a local access network. Connections between the cloud gaming server system 100 and one or more of the client devices 120ₙ (1≦n≦N) may comprise one or more channels. These channels can be made up of physical and/or logical links, and may travel over a variety of physical media, including radio frequency, fiber optic, free-space optical, coaxial and twisted pair. The channels may abide by a protocol such as UDP or TCP/IP. Also, one or more of the channels may be supported a virtual private network (VPN). In some embodiments, one or more of the connections may be session-based.

The server system 100 may enable users of the client devices 120ₙ (1≦n≦N) to play video games, either individually (i.e., a single-player video game) or in groups (i.e., a multi-player video game). The server system 100 may also enable users of the client devices 120ₙ (1≦n≦N) to spectate games (join as a spectator in games) being played by other players. Non-limiting examples of video games may include games that are played for leisure, education and/or sport. A video game may but need not offer users the possibility of monetary gain.

The server system 100 may also enable users of the client devices 120ₙ (1≦n≦N) to test video games and/or administer the server system 100.

The server system 100 may include one or more computing resources, possibly including one or more game servers, and may comprise or have access to one or more databases, possibly including a user (participant) database 10. The user database 10 may store account information about various users and client devices 120ₙ (1≦n≦N), such as identification data, financial data, location data, demographic data, connection data and the like. The game server(s) may be embodied in common hardware or they may be different servers that are connected via a communication link, including possibly over the Internet 130. Similarly, the database(s) may be embodied within the server system 100 or they may be connected thereto via a communication link, possibly over the Internet 130.

The server system 100 may implement an administrative application for handling interaction with client devices 120ₙ (1≦n≦N) outside the game environment, such as prior to game play. For example, the administrative application may be configured for registering a user of one of the client devices 120ₙ (1≦n≦N) in a user class (such as a “player”, “spectator”, “administrator” or “tester”), tracking the user's connectivity over the Internet, and responding to the user's command(s) to launch, join, exit or terminate an instance of a game, among several non-limiting functions. To this end, the administrative application may need to access the user database 10.

The administrative application may interact differently with users in different user classes, which may include “player”, “spectator”, “administrator” and “tester”, to name a few non-limiting possibilities. Thus, for example, the administrative application may interface with a player (i.e., a user in the “player” user class) to allow the player to set up an account in the user database 10 and select a video game to play. Pursuant to this selection, the administrative application may invoke a server-side video game application. The server-side video game application may be defined by computer-readable instructions that execute a set of modules for the player, allowing the player to control a character, avatar, race car, cockpit, etc. within a virtual world of a video game. In the case of a multi-player video game, the virtual world may be shared by two or more players, and one player's game play may affect that of another. In another example, the administrative application may interface with a spectator (i.e., a user in the “spectator” user class) to allow the spectator to set up an account in the user database 10 and select a video game from a list of ongoing video games that the user may wish to spectate. Pursuant to this selection, the administrative application may invoke a set of modules for that spectator, allowing the spectator to observe game play of other users but not to control active characters in the game. (Unless otherwise indicated, where the term “user” is employed, it is meant to apply equally to both the “player” user class and the “spectator” user class.)

In a further example, the administrative application may interface with an administrator (i.e., a user in the “administrator” user class) to allow the administrator to change various features of the game server application, perform updates and manage player/spectator accounts.

In yet another example, the game server application may interface with a tester (i.e., a user in the “tester” user class) to allow the tester to select a video game to test. Pursuant to this selection, the game server application may invoke a set of modules for the tester, allowing the tester to test the video game.

FIG. 1B illustrates interaction that may take place between client devices 120ₙ (1≦n≦N) and the server system 100 during game play, for users in the “player” or “spectator” user class.

In some non-limiting embodiments, the server-side video game application may cooperate with a client-side video game application, which can be defined by a set of computer-readable instructions executing on a client device, such as client device 120ₙ (1≦n≦N). Use of a client-side video game application may provide a customized interface for the user to play or spectate the game and access game features. In other non-limiting embodiments, the client device does not feature a client-side video game application that is directly executable by the client device. Rather, a web browser may be used as the interface from the client device's perspective. The web browser may itself instantiate a client-side video gave application within its own software environment so as to optimize interaction with the server-side video game application.

The client-side video game application running (either independently or within a browser) on the given client device may translate received user inputs and detected user movements into “client device input”, which may be sent to the cloud gaming server system 100 over the Internet 130.

In the illustrated embodiment of FIG. 1B, client devices 120ₙ (1≦n≦N) may produce client device input 140ₙ (1≦n≦N), respectively. The server system 100 may process the client device input 140ₙ (1≦n≦N) received from the various client devices 120ₙ (1≦n≦N) and may generate respective “media output” 150ₙ (1≦n≦N) for the various client devices 120ₙ (1≦n≦N). The media output 150ₙ (1≦n≦N) may include a stream of encoded video data (representing images when displayed on a screen) and audio data (representing sound when played via a loudspeaker). The media output 150ₙ (1≦n≦N) may be sent over the Internet 130 in the form of packets. Packets destined for a particular one of the client devices 120ₙ (1≦n≦N) may be addressed in such a way as to be routed to that device over the Internet 130. Each of the client devices 120ₙ (1≦n≦N) may include circuitry for buffering and processing the media output in the packets received from the cloud gaming server system 100, as well as a display for displaying images and a transducer (e.g. a loudspeaker) for outputting audio. Additional output devices may also be provided, such as an electro-mechanical system to induce motion.

It should be appreciated that a stream of video data can be divided into “frames”. The term “frame” as used herein does not require the existence of a one-to-one correspondence between frames of video data and images represented by the video data. That is to say, while it is possible for a frame of video data to contain data representing a respective displayed image in its entirety, it is also possible for a frame of video data to contain data representing only part of an image, and for the image to in fact require two or more frames in order to be properly reconstructed and displayed. By the same token, a frame of video data may contain data representing more than one complete image, such that N images may be represented using M frames of video data, where M<N.

Cloud Gaming Server System 100 (Distributed Architecture)

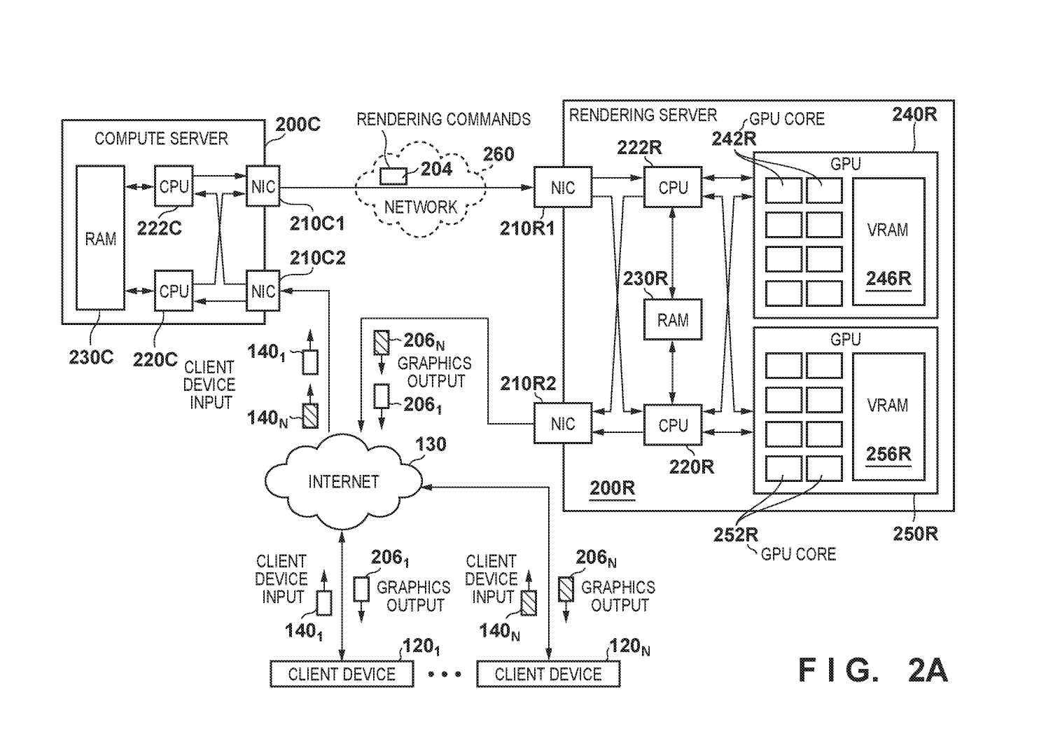

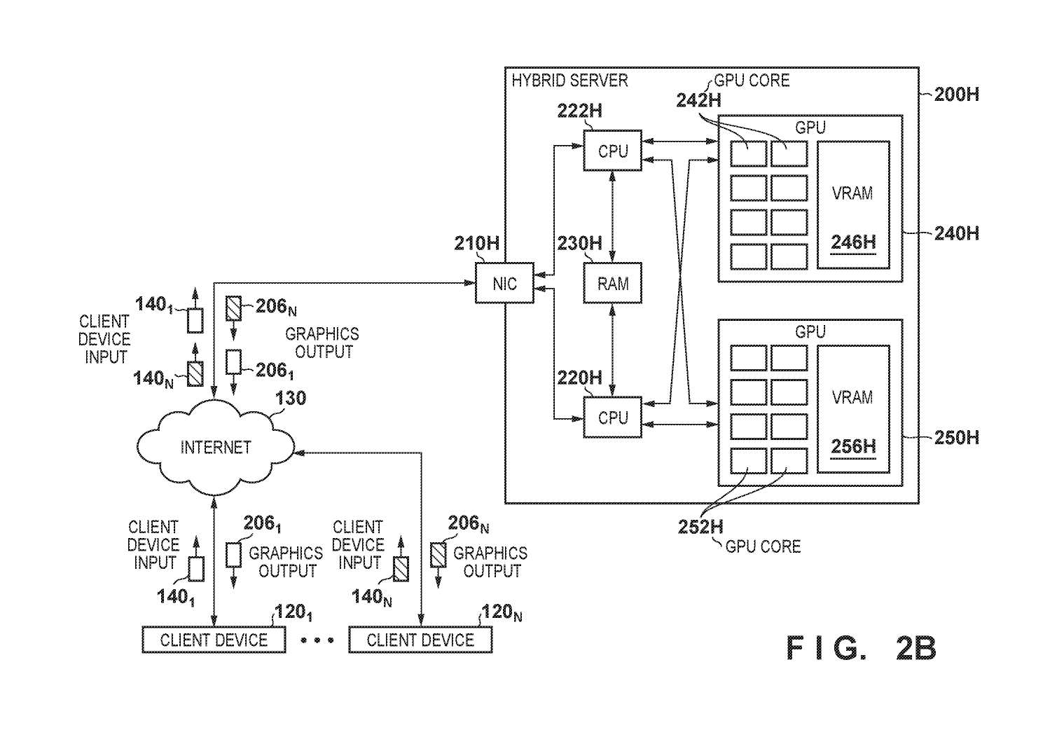

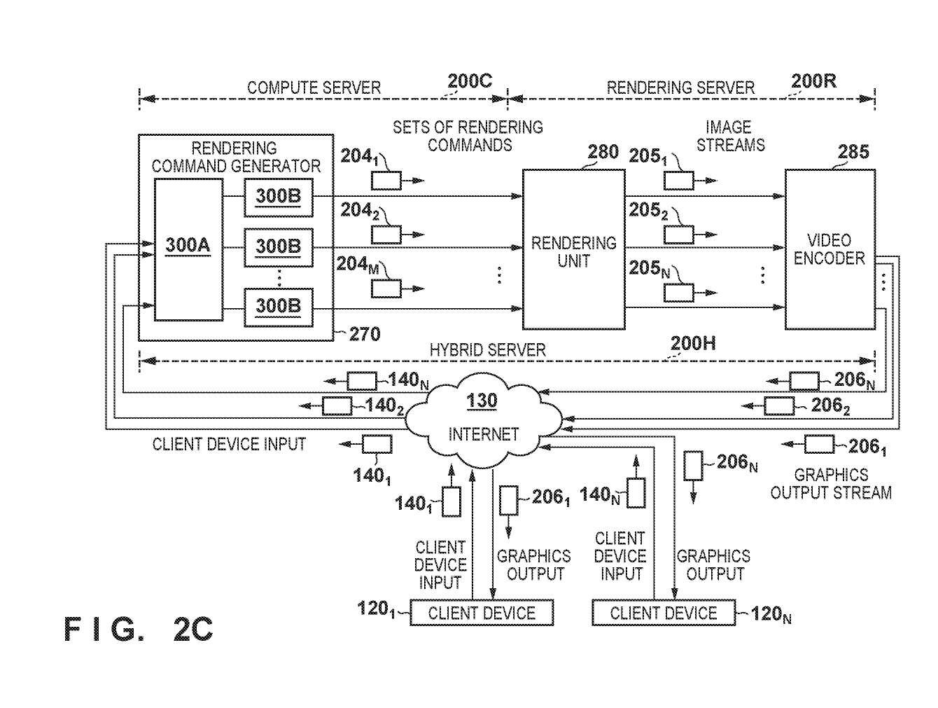

FIG. 2A shows one possible non-limiting physical arrangement of components for the cloud gaming server system 100. In this embodiment, individual servers within the cloud gaming server system 100 may be configured to carry out specialized functions. For example, a compute server 200C may be primarily responsible for tracking state changes in a video game based on user input, while a rendering server 200R may be primarily responsible for rendering graphics (video data).

The users of client devices 120ₙ (1≦n≦N) may be players or spectators. It should be understood that in some cases there may be a single player and no spectator, while in other cases there may be multiple players and a single spectator, in still other cases there may be a single player and multiple spectators and in yet other cases there may be multiple players and multiple spectators.

For the sake of simplicity, the following description refers to a single compute server 200C connected to a single rendering server 200R. However, it should be appreciated that there may be more than one rendering server 200R connected to the same compute server 200C, or more than one compute server 200C connected to the same rendering server 200R. In the case where there are multiple rendering servers 200R, these may be distributed over any suitable geographic area.

As shown in the non-limiting physical arrangement of components in FIG. 2A, the compute server 200C may comprise one or more central processing units (CPUs) 220C, 222C and a random access memory (PAM) 230C. The CPUs 220C, 222C can have access to the RAM 230C over a communication bus architecture, for example. While only two CPUs 220C, 222C are shown, it should be appreciated that a greater number of CPUs, or only a single CPU, may be provided in some example implementations of the compute server 200C. The compute server 200C may also comprise a receiver for receiving client device input over the Internet 130 from each of the client devices participating in the video game. In the presently described example embodiment, client devices 120ₙ (1≦n≦N) are assured to be participating in the video game, and therefore the received client device input may include client device input 140ₙ (1≦n≦N). In a non-limiting embodiment, the receiver may be implemented by a network interface component (NIC) 210C2.

The compute server 200C may further comprise transmitter for outputting sets of rendering commands 204ₙ, where 1≦m≦M. In a non-limiting embodiment, M represents the number of users (or client devices), but this need not be the case in every embodiment, particularly where a single set of rendering commands is shared among multiple users. Thus, M simply represents the number of generated sets of rendering commands. The sets of rendering commands 204ₘ (1≦m≦M) output from the compute server 200C may be sent to the rendering server 200R. In a non-limiting embodiment, the transmitter may be embodied by a network interface component (NIC) 210C1. In one embodiment, the compute server 200C may be connected directly to the rendering server 200R. In another embodiment, the compute server 200C may be connected to the rendering server 200R over a network 260, which may be the Internet 130 or another network. A virtual private network (VPN) may be established between the compute server 200C and the rendering server 200R over the network 260.

At the rendering server 200R, the sets of rendering commands 204ₘ (1≦m≦M) sent by the compute server 200C may be received at a receiver (which may be implemented by a network interface component (NIC) 210R1) and may be directed to one or more CPUs 220R, 222R. The CPUs 220R, 222R may be connected to graphics processing units (GPUs) 240R, 250R. By way of non-limiting example, GPU 240R may include a set of GPU cores 242R and a video random access memory (VRAM) 246R. Similarly, GPU 250R may include a set of GPU cores 252R and a video random access memory (VRAM) 256R. Each of the CPUs 220R, 222R may be connected to each of the GPUs 240R, 250R or to a subset of the GPUs 240R, 250R. Communication between the CPUs 220R, 222R and the GPUs 240R, 250R can be established using, for example, a communication bus architecture. Although only two CPUs and two GPUs are shown, there may be more than two CPUs and GPUs, or even just a single CPU or GPU, in a specific example of implementation of the rendering server 200R.

The CPUs 220R, 222R may cooperate with the GPUs 240R, 250R to convert the sets of rendering commands 204ₘ (1≦m≦M) into graphics output streams 206ₙ, where 1≦n≦N and where N represents the number of users (or client devices) participating in the video game. Specifically, there may be N graphics output streams 206ₙ (1≦n≦N) for the client devices 120ₙ (1≦n≦N), respectively. This will be described in further detail later on. The rendering server 200R may comprise a further transmitter (which may be implemented by a network interface component (NIC) 210R2), through which the graphics output streams 206ₙ (1≦n≦N) may be sent to the client devices 120ₙ (1≦n≦N, respectively.

Cloud Gaming Server System 100 (Hybrid Architecture)

FIG. 2B shows a second possible non-limiting physical arrangement of components for the cloud gaming server system 100. In this embodiment, a hybrid server 200H may be responsible both for tracking state changes in a video game based on user input, and for rendering graphics (video data).

As shown in the non-limiting physical arrangement of components in FIG. 2B, the hybrid server 200H may comprise one or more central processing units (CPUs) 220H, 222H and a random access memory (RAM) 230H. The CPUs 220H, 222H may have access to the RAM 230H over a communication bus architecture, for example. While only two CPUs 220H, 222H are shown, it should be appreciated that a greater number of CPUs, or only a single CPU, may be provided in some example implementations of the hybrid server 200H. The hybrid server 200H may also comprise a receiver for receiving client device input is received over the Internet 130 from each of the client devices participating in the video game. In the presently described example embodiment, client devices 120ₙ (1≦n≦N) are assumed to be participating in the video game, and therefore the received client device input may include client device input 140ₙ (1≦n≦N). In a non-limiting embodiment, the receiver may be implemented by a network interface component (NIC) 210H.

In addition, the CPUs 220H, 222H may be connected to a graphics processing units (GPUs) 240H, 250H. By way of non-limiting example, GPU 240H may include a set of GPU cores 242H and a video random access memory (VRAM) 246H. Similarly, GPU 250H may include a set of GPU cores 252H and a video random access memory (VRAM) 256H. Each of the CPUs 220H, 222H may be connected to each of the GPUs 240H, 250H or to a subset of the GPUs 240H, 250H. Communication between the CPUs 220H, 222H and the GPUs 240H, 250H may be established using, for example, a communications bus architecture. Although only two CPUs and two GPUs are shown, there may be more than two CPUs and GPUs, or even just a single CPU or GPU, in a specific example of implementation of the hybrid server 200H.

The CPUs 220H, 222H may cooperate with the GPUs 240H, 250H to convert the sets of rendering commands 204ₘ (1≦m≦M) into graphics output streams 206ₙ (1≦n≦N). Specifically, there may be N graphics output streams 206ₙ (1≦n≦N) for the participating client devices 120ₙ (1≦n≦N), respectively. The graphics output streams 206ₙ (1≦n≦N) may be sent to the client devices 120ₙ (1≦n≦N), respectively, via a transmitter which, in a non-limiting embodiment, may be implemented at least in part by the NIC 210H.

Cloud Gaming Server System 100 (Functionality Overview)

During game play, the server system 100 runs a server-side video game application, which can be composed of a set of modules. With reference to FIG. 2C, these modules may include a rendering command generator 270, a rendering unit 280 and a video encoder 265. These modules may be implemented by the above-described physical components of the compute server 200C and the rendering server 200R (in FIG. 2A) and/or of the hybrid server 200H (in FIG. 2B). For example, according to the non-limiting embodiment of FIG. 2A, the rendering command generator 270 may be implemented by the compute server 200C, while the rendering unit 280 and the video encoder 285 may be implemented by the rendering server 200H. According to the non-limiting embodiment of FIG. 2B, the hybrid server 200H may implement the rendering command generator 270, the rendering unit 280 and the video encoder 285.

The present example embodiment discusses a single rendering command generator 270 for simplicity of illustration. However, it should be noted that in an actual implementation of the cloud gaming server system 100, many rendering command generators similar to the rendering command generator 270 may be executed in parallel. Thus, the cloud gaming server system 100 may support multiple independent instantiations of the same video game, or multiple different video games, simultaneously. Also, it should be noted that the video games can be single-player video games or multi-player games of any type.

The rendering command generator 270 may be implemented by certain physical components of the compute server 200C (in FIG. 2A) or of the hybrid server 200H (in FIG. 2B). Specifically, the rendering command generator 270 may be encoded as computer-readable instructions that are executable by a CPU (such as the CPUs 220C, 222C in the compute server 200C or the CPUs 220H, 222H in the hybrid server 200H). The instructions can be tangibly stored in the RAM 230C (in the compute server 203C) of the RAM 230H (in the hybrid server 200H) or in another memory area, together with constants, variables and/or other data used by the rendering command generator 270. In some embodiments, the rendering command generator 270 may be executed within the environment of a virtual machine that may be supported by an operating system that is also being executed by a CPU (such as the CPUs 220C, 222C in the compute server 200C or the CPUs 220H, 222H in the hybrid server 200H).

The rendering unit 280 may be implemented by certain physical components of the rendering server 200R (in FIG. 2A) or of the hybrid server 200H (in FIG. 2B). In an embodiment, the rendering unit 280 may take up one or more GP s (240R, 250R in FIG. 2A, 240H, 250H in FIG. 2B) and may or may not utilize CPU resources.

The video encoder 285 may be implemented by certain physical components of the rendering server 200R (in FIG. 2A) or of the hybrid server 200H (in FIG. 2B). Those skilled in the art will appreciate that there are various ways in which to implement the video encoder 285. In the embodiment of FIG. 2A, the video encoder 285 may be implemented by the CPUs 220R, 222R and/or by the GPUs 240R, 250R. In the embodiment of FIG. 2B, the video encoder 285 may be implemented by the CPUs 220H, 222H and/or by the GPUs 240H, 250H. In yet another embodiment, the video encoder 285 may be implemented by a separate encoder chip (not shown).

In operation, the rendering command generator 270 may produce the sets of rendering commands 204ₘ (1≦m≦M), based on received client device input 140ₙ (1≦n≦N). The received client device input may carry data (e.g., an address) identifying the rendering command generator 270 for which it is destined, and/or possibly data identifying the user and/or client device from which it originates.

Rendering commands refer to commands which may be used to instruct a specialized graphics processing unit (GPU) to produce a frame of video data or a sequence of frames of video data. Referring to FIG. 2C, the sets of rendering commands 204ₘ (1≦m≦M) result in the production of frames of video data by the rendering unit 280. The images represented by these frames may change as a function of responses to the client device input 140ₙ (1≦n≦N) that are programmed into the rendering command generator 270. For example, the rendering command generator 270 may be programmed in such a way as to respond to certain specific stimuli to provide the user with an experience of progression (with future interaction being made different, more challenging or more exciting), while the response to certain other specific stimuli will provide the user with an experience of regression or termination. Although the instructions for the rendering command generator 270 may be fixed in the form of a binary executable file, the client device input 140ₙ (1≦n≦N) is unknown until the moment of interaction with a player who uses the corresponding client device 120ₙ (1≦n≦N). As a result, there can be a wide variety of possible outcomes, depending on the specific client device input that is provided. This interaction between players/spectators and the rendering command generator 270 via the client devices 120ₙ (1≦n≦N) can be referred to as “game play” or “playing a video game”.

The rendering unit 280 may process the sets of rendering commands 204ₘ (1≦m≦M) to create multiple video data streams 205ₙ (1≦n≦N, where N refers to the number of users/client devices participating in the video game). Thus, there may generally be one video data stream created per user (or, equivalently, per client device). When performing rendering, data for one or acre objects represented in three-dimensional space (e.g., physical objects) or two-dimensional space (e.g., text) may be loaded into a cache memory (not shown) of a particular GPU 240R, 250R, 240H, 250H. This data may be transformed by the GPU 240R, 250R, 240H, 250H into data representative of a two-dimensional image, which may be stored in the appropriate VRAM 246R, 256R, 246H, 256H. As such, the VRAM 246K, 256R, 246H, 256H may provide temporary storage of picture element (pixel) values for a game screen.

The video encoder 285 may compress and encodes the video data in each of the video data streams 205ₙ (1≦n≦N) into a corresponding stream of compressed/encoded video data. The resultant streams of compressed/encoded video data, referred to as graphics output screams, way be produced on a per-client-device basis. In the present example embodiment, the video encoder 285 may produce graphics output streams 206ₙ (1≦n≦N) for client devices 120ₙ (1≦n≦N), respectively. Additional modules may be provided for formatting the video data into packets so that they can be transmitted over the Internet 130. The video data in the video data streams 205ₙ (1≦n≦N) and the compressed/encoded video data within a given graphics output stream may be divided into frames.

Generation of Rendering Commands

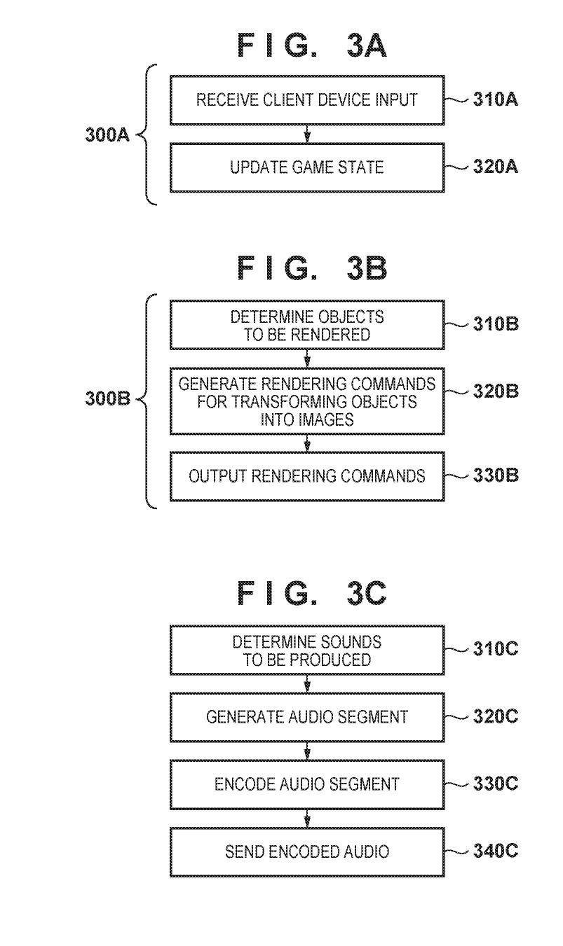

Generation of rendering commands by the rendering command generator 270 is now described in greater detail with reference to FIGS. 2C, 3A and 3B. Specifically, execution of the rendering command generator 270 may involve several processes, including a main game process 300A and a graphics control process 300B, which are described herein below in greater detail.

Main Game Process

The main game process 300A is described with reference to FIG. 3A. The main game process 300A may execute repeatedly as a continuous loop. As part of the main game process 300A, there may be provided an action 310A, during which client device input may be received. If the video game is a single-player video game without the possibility of spectating, then client device input (e.g., client device input 140₁) from a single client device (e.g., client device 120₁) is received as part of action 310A. If the video game is a multi-player video game or is a single-player video game with the possibility of spectating, then the client device input from one or more client devices may be received as part of action 310A.

By way of non-limiting example, the input from a given client device may convey that the user of the given client device wishes to cause a character under his or her control to move, jump, kick, turn, swing, pull, grab, etc. Alternatively or in addition, the input from the given client device may convey a menu selection made by the user of the given client device in order to change one or more audio, video or gameplay settings, to load/save a game or to create or join a network session. Alternatively or in addition, the input from the given client device may convey that the user of the given client device wishes to select a particular camera view (e.g., first-person or third-person) or reposition his or her viewpoint within the virtual world.

At action 320A, the game state may be updated based at least in part on the client device input received at action 310A and other parameters. Updating the game state may involve the following actions: Firstly, updating the game state may involve updating certain properties of the user (player or spectator) associated with the client devices from which the client device input may have been received. These properties may be stored in the user database 10. Examples of user properties that may be maintained in the user database 10 and updated at action 320A can include a camera view selection (e.g., 1^{st} person, 3^{rd} person), a mode of play, a selected audio or video setting, a skill level, a customer grade (e.g., guest, premium, etc.).

Secondly, updating the game state may involve updating the attributes of certain objects in the virtual world based on an interpretation of the client device input. The objects whose attributes are to be updated may in some cases be represented by two- or three-dimensional models and may include playing characters, non-playing characters and other objects. In the case of a playing character, attributes that can be updated may include the object's position, strength, weapons/armor, lifetime left, special powers, speed/direction (velocity), animation, visual effects, energy, ammunition, etc. In the case of other objects (such as background, vegetation, buildings, vehicles, score board, etc.), attributes that can be updated may include the object's position, velocity, animation, damage/health, visual effects, textual content, etc.

It should be appreciated that parameters other than client device input may influence the above properties (of users) and attributes (of virtual world objects). For example, various timers (such as elapsed time, time since a particular event, virtual time of day, total number of players, a user's geographic location, etc.) can have an effect on various aspects of the game state.

Once the game state has been updated further to execution of action 320A, the main game process 300A may return to action 310A, whereupon new client device input received since the last pass through the main game process is gathered and processed.

Graphics Control Process

A second process, referred to as the graphics control process, is now described with reference to FIG. 3B. Although shown as separate from the main game process 300A, the graphics control process 300B may execute as an extension of the main game process 300A. The graphics control process 300B may execute continually resulting in generation of the sets of rendering commands 204ₘ (1≦m≦H). In the case of a single-player video game without the possibility of spectating, there is only one user (i.e., N=1) and therefore only one resulting set of rendering commands 204₁ (i.e., M=1) to be generated. In other cases, N (the number of users) is greater than 1. For example, in the case of a multi-player video game, multiple distinct sets of rendering commands (M>1) need to be generated for the multiple players, and therefore multiple sub-processes may execute in parallel, one for each player. On the other hand, in the case of a single-player game with the possibility of spectating (again, multiple users and therefore N>1), there may be only a single set of rendering commands 204₁ (M=1), with the resulting video data stream being duplicated for the spectators by the rendering unit 280. Of course, these are only examples of implementation and are not to be taken as limiting.

Consider operation of the graphics control process 300B for a given user requiring one of the video data streams 205ₙ (1≦n≦N). At action 310B, the rendering command generator 270 may determine the objects to be rendered for the given user. This action may include identifying the following types of objects: Firstly, this action may include identifying those objects from the virtual world that are in the “game screen rendering range” (also known as a “scene”) for the given user. The game screen rendering range may include a portion of the virtual world that would be “visible” from the perspective of the given user's camera. This may depend on the position and orientation of that camera relative to the objects in the virtual world. In a non-limiting example of implementation of action 310B, a frustum may be applied to the virtual world, and the objects within that frustum are retained or marked. The frustum has an apex which may be situated at the location of the given user's camera and may have a directionality also defined by the directionality of that camera.

Secondly, this action can include identifying additional objects that do not appear in the virtual world, but which nevertheless may need to be rendered for the given user. For example, these additional objects may include textual messages, graphical warnings and dashboard indicators, to name a few non-limiting possibilities.

At action 320B, the rendering command generator 270 may generate a set of commands 204ₘ (1≦m≦M) for rendering into graphics (video data) the objects that were identified at action 310B. Rendering may refer to the transformation of 3-D or 2-D coordinates of an object or group of objects into data representative of a displayable image, in accordance with the viewing perspective and prevailing lighting conditions. This may be achieved using any number of different algorithms and techniques, for example as described in “Computer Graphics and Geometric Modelling: Implementation & Algorithms”, Max K. Agoston, Springer-Verlag London Limited, 2005, hereby incorporated by reference herein. The rendering commands may have a format that in conformance with a 3D application programming interface (API) such as, without limitation, “Direct3D” from Microsoft Corporation, Redmond, Wash., and “OpenGL” managed by Khronos Group, Beaverton, Oreg.

At action 330B, the rendering commands generated at action 320B may be output to the rendering unit 280. This may involve packetizing the generated rendering commands into a set of rendering commands 204ₘ (1≦m≦M) that is sent to the rendering unit 280.

Generation of Graphics Output

The rendering unit 280 may interpret the sets of rendering commands 204ₘ (1≦m≦M) and produce multiple video data streams 205ₙ (1≦n≦N), one for each of the N participating client devices 120ₙ(1≦n≦N). Rendering may be achieved by the GPUs 240R, 250R, 240H, 250H under control of the CPUs 220R, 222R (in FIG. 2A) or 220H, 222H (in FIG. 2B). The rate at which frames of video data are produced for a participating client device may be referred to as the frame rate.

In an embodiment where there are N users, the N video data streams 205ₙ (1≦n≦N) may be created from respective sets of rendering commands 204ₘ (1≦m≦M, where M=N). In that case, rendering functionality is not shared among the users. However, the N video data streams 205ₙ (1≦n≦N) may also be created from M sets of rendering commands 204ₘ) (1≦m≦M, where M is less than N), such that fewer sets of rendering commands need to be processed by the rendering unit 280. In that case, the rendering unit 280 may perform sharing or duplication in order to generate a larger number of video data streams 205ₙ (1≦n≦N) from a smaller number of sets of rendering commands 204ₘ (1≦m≦M, where M<N). Such sharing or duplication may be prevalent when multiple users (e.g., spectators) desire to view the same camera perspective. Thus, the rendering unit 280 may perform functions such as duplicating a created video data stream for one or more spectators.

Next, the video data in each of the video data streams 205ₙ (1≦n≦N) may be encoded by the video encoder 285, resulting in a sequence of encoded video data associated with each client device, referred to as a graphics output stream. In the example embodiments of FIGS. 2A-2C, the sequence of encoded video data destined for each of the client devices 120ₙ (1≦n≦N) is referred to as graphics output stream 206ₙ (1≦n≦N).

The video encoder 285 may be a device for set of computer-readable instructions) that enables or carries out or defines a video compression or decompression algorithm for digital video. Video compression may transform an original stream of digital image data (expressed in terms of pixel locations, color values, etc.) into an output stream of digital image data that conveys substantially the same information but using fewer bits. Any suitable compression algorithm may be used. In addition to data compression, the encoding process used to encode a particular frame of video data way or may not involve cryptographic encryption.

The graphics output streams 206ₙ (1≦n≦N) created in the above manner may be sent over the Internet 130 to the respective client devices. By way of non-limiting example, the graphics output streams may be segmented and formatted into packets, each having a header and a payload. The header of a packet containing video data for a given user may include a network address of the client device associated with the given user, while the payload may include the video data, in whole or in part. In a non-limiting embodiment, the identity and/or version of the compression algorithm used to encode certain video data way be encoded in the content of one or more packets that convey that video data. Other methods of transmitting the encoded video data may occur to those of skill in the art.

While the present description focuses on the rendering of video data representative of individual 2-D images, the present invention does not exclude the possibility of rendering video data representative of multiple 2-D images per frame to create a 3-D effect.

Game Screen Reproduction at Client Device

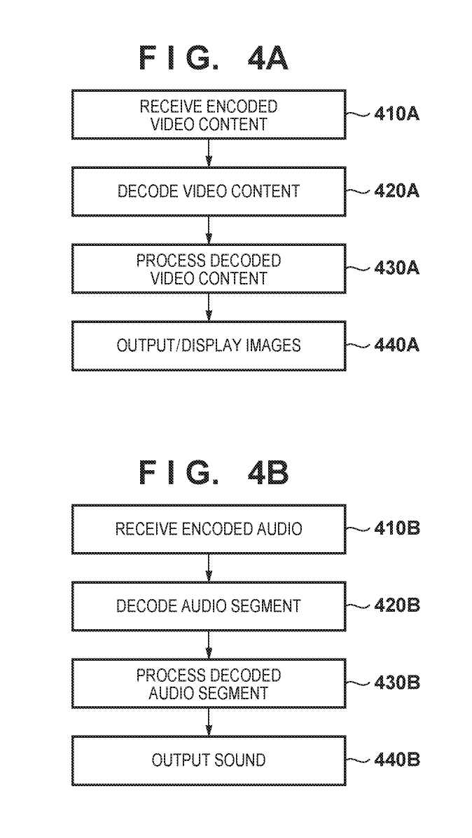

Reference is now made to FIG. 4A, which shows operation of a client-side video game application that may be executed by the client device associated with a given user, which may be any of the client devices 120ₙ (1≦n≦N), by way of non-limiting example. In operation, the client-side video game application may be executable directly by the client device or it may run within a web browser, to name a few non-limiting possibilities.

At action 410A, a graphics output stream (from among the graphics output streams 206ₙ (1≦n≦N)) may be received over the Internet 130 from the rendering server 200R (FIG. 2A) or from the hybrid server 200H (FIG. 2B), depending on the embodiment. The received graphics output stream may comprise compressed/encoded of video data which may be divided into frames.

At action 420A, the compressed/encoded frames of video data may be decoded/decompressed in accordance with the decompression algorithm that is complementary to the encoding/compression algorithm used in the encoding/compression process. In a non-limiting embodiment, the identity or version of the encoding/compression algorithm used to encode/compress the video data may be known in advance. In other embodiments, the identity or version of the encoding/compression algorithm used to encode the video data may accompany the video data itself.

At action 430A, the (decoded/decompressed) frames of video data may be processed. This can include placing the decoded/decompressed frames of video data in a buffer, performing error correction, reordering and/or combining the data in multiple successive frames, alpha blending, interpolating portions of missing data, and so on. The result may be video data representative of a final image to be presented to the user on a per-frame basis.

At action 440A, the final image may be output via the output mechanism of the client device. For example, a composite video frame may be displayed on the display of the client device.

Audio Generation

A third process, referred to as the audio generation process, is now described with reference to FIG. 3C. The audio generation process may execute continually for each user requiring a distinct audio stream. In one embodiment, the audio generation process may execute independently of the graphics control process 300B. In another embodiment, execution of the audio generation process and the graphics control process may be coordinated.

At action 310C, the rendering command generator 270 may determine the sounds to be produced. Specifically, this action may include identifying those sounds associated with objects in the virtual world that dominate the acoustic landscape, due to their volume (loudness) and/or proximity to the user within the virtual world.

At action 320C, the rendering command generator 270 may generate an audio segment. The duration of the audio segment may span the duration of a video frame, although in some embodiments, audio segments may be generated less frequently than video frames, while in other embodiments, audio segments may be generated more frequently than video frames.

At action 330C, the audio segment may be encoded, e.g., by an audio encoder, resulting in an encoded audio segment. The audio encoder can be a device (or set of instructions) that enables or carries out or defines an audio compression or decompression algorithm. Audio compression may transform an original stream of digital audio (expressed as a sound wave changing in amplitude and phase over time) into an output stream of digital audio data that conveys substantially the same information but using fewer bits. Any suitable compression algorithm may be used. In addition to audio compression, the encoding process used to encode a particular audio segment may or may not apply cryptographic encryption.

It should be appreciated that in some embodiments, the audio segments way be generated by specialized hardware (e.g., a sound card) in either the compute server 200C (FIG. 2A) or the hybrid server 200H (FIG. 2B). In an alternative embodiment that may be applicable to the distributed arrangement of FIG. 2A, the audio segment may be parameterized into speech parameters (e.g., LPC parameters) by the rendering command generator 270, and the speech parameters can be redistributed to the destination client device by the rendering server 200R.

The encoded audio created in the above manner is sent over the Internet 130. By way of non-limiting example, the encoded audio input may be broken down and formatted into packets, each having a header and a payload. The header may carry an address of a client device associated with the user for whom the audio generation process is being executed, while the payload may include the encoded audio. In a non-limiting embodiment, the identity and/or version of the compression algorithm used to encode a given audio segment may be encoded in the content of one or more packets that convey the given segment. Other methods of transmitting the encoded audio may occur to those of skill in the art.

Reference is now made to FIG. 4B, which shows operation of the client device associated with a given user, which may be any of client devices 120ₙ (1≦n≦N), by way of non-limiting example.

At action 410B, an encoded audio segment may be received from the compute server 200C, the rendering server 200R or the hybrid server 200H (depending on the embodiment). At action 420B, the encoded audio may be decoded in accordance with the decompression algorithm that is complementary to the compression algorithm used in the encoding process. In a non-limiting embodiment, the identity or version of the compression algorithm used to encode the audio segment may be specified in the content of one or more packets that convey the audio segment.

At action 430B, the (decoded) audio segments may be processed. This may include placing the decoded audio segments in a buffer, performing error correction, combining multiple successive waveforms, and so on. The result may be a final sound to be presented to the user on a per-frame basis.

At action 440B, the final generated sound may be output via the output mechanism of the client device. For example, the sound may be played through a sound card or loudspeaker of the client device.

### Specific Description of Non-Limiting Embodiments

A more detailed description of certain non-limiting embodiments of the present invention is now provided.

Reference is made to FIG. 31, which shows a general block diagram of a non-limiting embodiment of the present invention. The rendering command generator 270 supplies a set of rendering commands 204₁ to the rendering unit 280. A single set of rendering commands 204₁ is being considered here (i.e., M=1), resulting in multiple video data streams 205ₙ (1≦n≦N), one for each of the N users. This situation could arise when N users (players and/or spectators) share the same camera perspective. Of course, a similar description could apply to a case when there is more than 1 set of rendering commands (i.e., M>1), each of which may spawn one or more respective video data streams.

The set of rendering commands 204₁ is supplied to a renderer 1120 within the rendering unit 280. In the absence of certain embodiments of the present invention, the renderer 1120 might process the set of rendering commands 204₁ to produce frames destined for a single client device. However, in accordance with non-limiting embodiments of the present invention, the renderer 1120 processes the set of rendering commands 204₁ to produce a video data stream containing primary frames 540ₐ, 540_{b}, . . . , which are then customized by a customization unit 1110 to form the multiple video data streams 205ₙ (1≦n≦N), one for each of the N users.

The customization unit 1110 receives customization information for each user from the rendering command generator 270. Here, it should be noted that the customization unit may not receive the customization information for all of the users. That is, for some users, a non-customized primary frame may be output as the video data streams. Specifically, the customization information includes one or more pieces of customization information for each of one or more users (e.g., customization information 1150ₙ for user n, where 1≦n≦N). The customization unit 1110 interprets the customization information, obtains custom features, integrates the custom features into the primary frames 540ₐ, 540_{b}, . . . , and creates multiple video data streams 205ₙ (1≦n≦N), each containing a set of “composite frames” for the corresponding user. It is noted that the composite frames in the video data stream 205ₙ for user n (1≦n≦N) include a customized portion (one or more graphical elements) designated by the customization information for user n that has been added post-rendering. It is these composite frames that are encoded by the video encoder 285 into a customized graphics output stream (video content) 206ₙ for user n (1≦n≦N). The video encoder 285 may encode the composite frame in accordance with a motion picture standard.

There are many ways in which the graphical elements can be added to the primary frames 540ₐ, 540_{b}, . . . , to form a customized set of images for a given user. This can be achieved using several non-limiting example embodiments of the rendering unit 280 and the customization unit 1110, as will now be described.

### First Embodiment

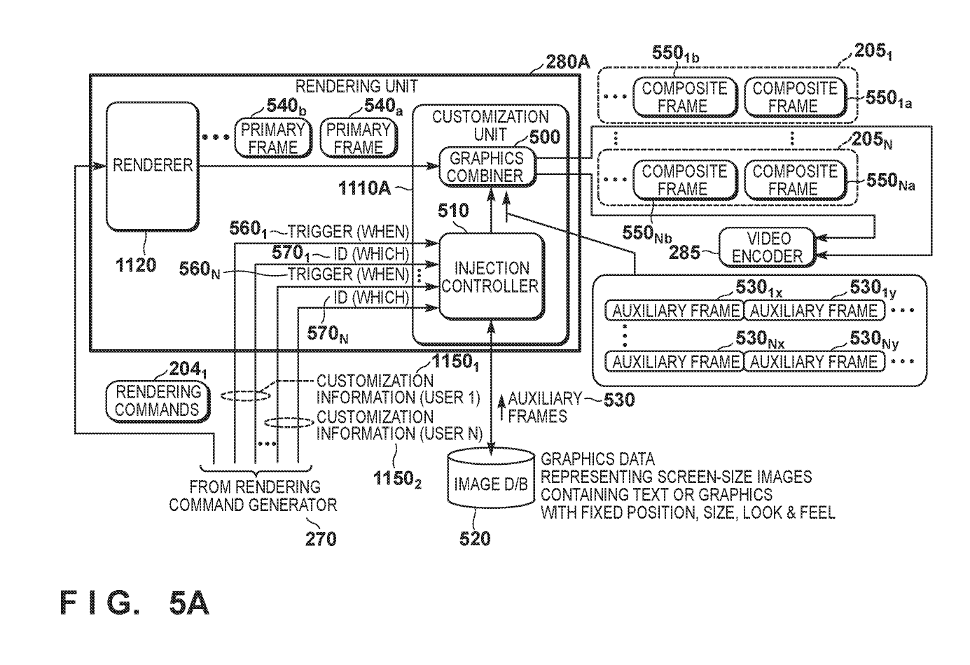

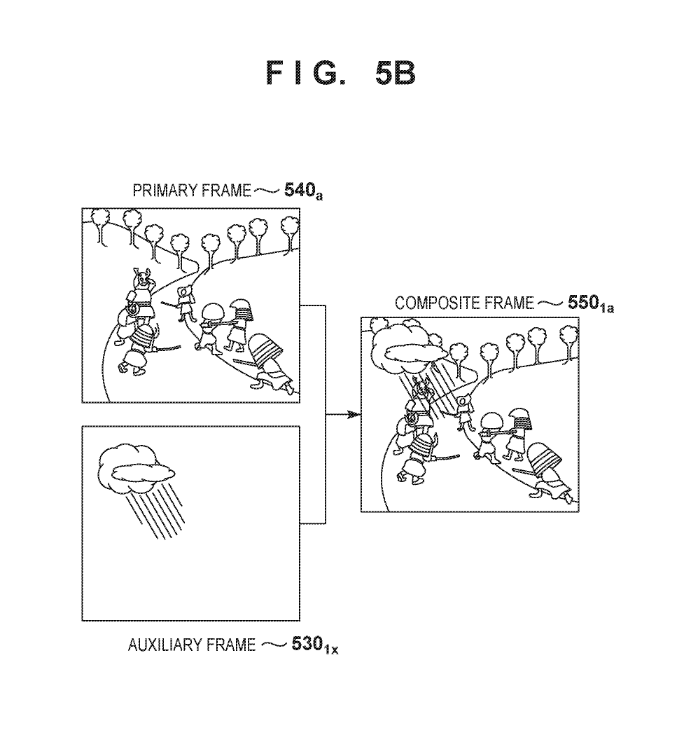

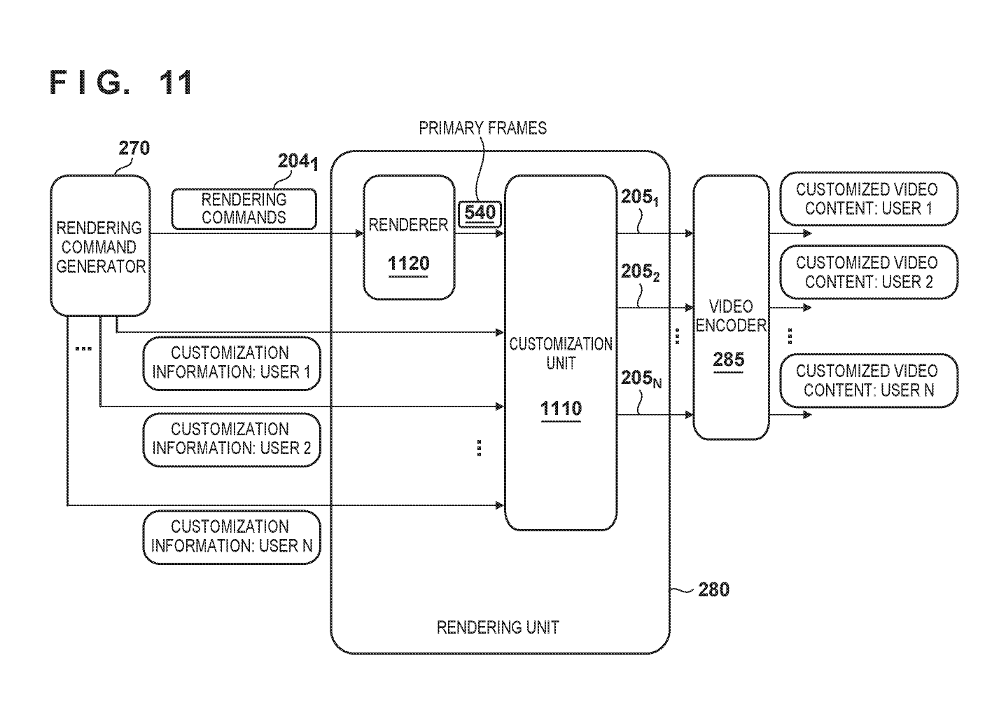

In the embodiment of FIG. 5A, the rendering unit 280 and customization unit 1110 of FIG. 11 are represented as rendering unit 280A and customization unit 1110A, respectively. The customization unit 1110A includes a graphics combiner 500 and an injection controller 510. The graphics combiner 500 is disposed along the path between the renderer 1120 and the video encoder 285. The graphics combiner 500 acquires a primary frame, which is rendered by the renderer 1120, and one or more auxiliary frames for each of users from, for example, an image database (D/B) 520 via the injection controller 510. The graphics combiner 500 then combines the primary frame and each of the one or more auxiliary frames to form one or more composite frames, each of which is generated for each of a plurality of users (user clients), and outputs the one or more composite frames to the video encoder 285. Each of encoded composite frames is transmitted, via e.g. the Internet, to is corresponding user terminal.

It is noted that the composite frames may not be generated for all of the user clients, and the primary frame may be encoded and transmitted to one or more, but not all of the user clients. For example, the graphics combiner 500 may output a primary frame for a first user, and a composite frame for a second user, which is generated by combining the primary frame with an “auxiliary” frame for the second user, while the graphics combiner 500 can output a first composite frame for the first user, which is generated by combining the primary frame with an auxiliary frame for the first user, and a second composite frame for the second user, which is generated by combining the primary frame with an auxiliary frame for the second user.

Consider the case of video data stream 205₁ containing composite frames 550₁ₐ, 550_{1b}, . . . . The graphics combiner 500 creates each of the composite frames 550₁ₐ, 550_{1b}, . . . , by combining a respective one of the primary frames 540ₐ, 540_{b}, . . . , with a particular auxiliary frame 530₁ₓ, 530_{1y}, . . . . The primary frames 540ₐ, 540_{b}, . . . , are rendered and supplied by the renderer 1120, whereas the auxiliary frames 530₁ₓ, 530_{1y}, . . . , may be derived from images stored in a database 520 and supplied by the injection controller 510. It is noted that the auxiliary frames 530₁ₓ, 530_{1y}, . . . , may be supplied by other ways, as described in the following embodiments. In addition, the auxiliary frames 530₁ₓ, 530_{1y}, . . . , may contain one or more pre-positioned graphical elements. The graphics combiner 500 blends the auxiliary frames 530₁ₓ, 530_{1y}, . . . , with the primary frames 540_{1y}, 540_{b}, . . . , resulting in the composite frames 550₁ₐ, 550_{1b}, . . . . For example, the graphics combiner 500 superimposes the auxiliary frame onto the primary frame. Blending may be achieved using a variety of techniques such as alpha compositing or bit-blitting.

Consider now the analogous case of video data stream 205₂ containing composite frames 550₂ₐ, 550_{2b}, . . . . The graphics combiner 500 creates each of the composite frames 550₂ₐ, 550_{2b}, . . . , by combining a respective one of the primary frames 540ₐ, 540_{b}, . . . with a particular auxiliary frame 530₂ₓ, 530_{2y}, . . . . The primary frames 540ₐ, 540_{b}, . . . , are rendered and supplied by the renderer 1120, whereas the auxiliary frames 530₂ₓ, 530_{2y}, . . . , are supplied by the injection controller 510. It is noted that the auxiliary frames 530₂ₓ, 530_{2y}, . . . , may be supplied by other ways, as described in the following embodiments. Also, the auxiliary frames 530₂ₓ, 530_{2y}, . . . , may contain one or more pre-positioned graphical elements. The graphics combiner 500 blends the auxiliary frames 530₂ₓ, 530_{2y}, . . . , with the primary frames 540ₐ, 540_{b}, . . . , resulting in the composite frames 550₂ₐ, 550_{2b}, . . . . For example, the graphics combiner 500 superimposes the auxiliary frame onto the primary frame.

As such, the composite frames 550₁ₐ, 550_{1b}, . . . , in video data stream 205₁ (for user 1) consist of the primary frames 540ₐ, 540_{b}, . . . , into which graphical elements from certain ones of the auxiliary frames 530₁ₓ, 530_{1y}, . . . , may have been incorporated. Similarly, the composite frames 550₂ₐ, 550_{2b}, . . . , in video data stream 205₂ (for user 2 sharing the same scene as user 1) consist of those same primary frames 540ₐ, 540_{b}, . . . , into which graphical elements from certain other ones of the auxiliary frames 530₂ₓ, 530_{2y}, . . . , may have been incorporated. It should be appreciated that not all composite frames are formed from a primary frame and an auxiliary frame. For example, in some cases a primary frame might make it through the customization unit 1110A unmodified by any auxiliary frame.

With additional reference to FIG. 5B, there is shown an example primary frame 540ₐ, an example auxiliary frame 530₁ₓ and an example composite frame 550₁ₐ. The auxiliary frame 530₁ₐ can be a screen-size frame that contains one or more customized graphical elements (e.g., text or graphics) for user 1. The graphical elements may only occupy a fraction of the screen, and have a size, position and characteristic quality that is pre-determined. The characteristic quality may be referred to as “look and feel”, and may include at least one of font, layout, shape and color. In the specific case of text, the “look and feel” can refer to the font, color, style, etc., having generally accepted definitions. In the case of graphics, the “look and feel” can refer to a qualitative characteristic appearance of a frame based on patterns, styles, colors and shapes. That is, the characteristic quality indicates how the graphical elements are presented in the composite frame. The characteristic quality may be defined for each of the graphical elements. For example, a characteristic quality for one of the graphical elements may differ from that for another one of the graphical elements. In addition, the characteristic quality may be defined only for a portion of the graphical elements The database 520 may be referred to as an image information database, as it stores image information. In some embodiments, the image information may constitute frames with pre-positioned graphical elements. In other embodiments, the image information stored in the database 520 may constitute individual graphical elements without a pre-set position oz size, and which can be positioned and sized within a frame according to external specifications. In the case of the embodiment of FIG. 5A, the database 520 may contain frames including the auxiliary frames 530₁ₓ, 530_{1y}, . . . , 530₂ₓ, 530_{2y}, . . . , 530_{Nx}, 530_{Ny}, . . . . The auxiliary frames may thus represent images stored in the image information database 520, each image containing pre-positioned graphical elements. Individual images in the database 520 may be given a unique identifier (ID) so that they can be easily accessed. The database 520 may be updated dynamically so as to allow the images stored therein to change.

Returning to FIG. 5A, in order to retrieve the appropriate images from the image database 520 and to supply them to the graphics combiner 500 at the appropriate time, the injection controller 510 accepts customization information 1150ₙ (1≦n≦N) for the various users from the rendering command generator 270. In the present non-limiting embodiment, the customization information 1150₁ for user 1 may include an insertion timing signal (referred to as a “trigger” signal) 560₁ and an TD signal 570₁. The ID signal 570₁ identifies which images are the correct ones to retrieve from the database 520 and to use in the auxiliary frames 530₁ₓ, 530_{1y}, . . . . The trigger signal 560₁ identifies the timing/synchronization regarding the retrieved image, i.e., the trigger signal designates a time at which the injection controller 510 provides these auxiliary frames 530₁ₓ, 530_{1y}, . . . to the graphics combiner 500 for injection into the corresponding primary frames 540ₐ, 540_{b}, . . . or at which the graphics combiner 500 combines these auxiliary frames 530₁ₓ, 530_{1y}, . . . with the corresponding primary frames 540ₐ, 540_{b}, . . . . Here, the trigger signal may designate a time in a real world or a time in a virtual world of a video game. In the former case, the injection controller 510 may comprise a real-time clock for identifying the insertion time of the auxiliary frames. In the latter case, the injection controller 510 may comprise a unit for acquiring a frame number of the video game, for example, a frame counter, so that the injection controller can provide the auxiliary frames to the graphics combiner 500 at the appropriate time. In this case, the primary frame 540 may be input to the injection controller 510 for counting up the frame number, or the injection controller 510 may obtain the frame number being counted up at the graphics combiner 500. The injection controller 510 may acquire information indicating the time of the virtual world of the video game other than the frame number.

It is noted that identification of the appropriate image to extract from the image database 520 (using the ID signals 570₁, . . . , 570_{N}) can depend on a variety of factors, such as each user's identity, demographic information, socio-economic status, geographic location, etc. Also, there may be times during gameplay when it is more desirable (or less desirable) for the auxiliary frames to be injected into the primary frames and this is controlled by the respective trigger signals 570₁, . . . , 570_{N}. As such, the trigger signal 560ₙ for user n (1≦n≦N) indicates the appropriate moments(s) at which to supply the auxiliary frames 530₁ₐ, 530_{1b}, . . . to the graphics combiner 500.

In one non-limiting embodiment, the rendering command generator 270 executing on the compute server 200C is pre-programmed to produce the ID signals 570₁, . . . , 570_{N} and the trigger signals 560₁, . . . , 560_{N} at certain predefined points in the video game and to supply these signals to the injection controller 510. As a result, the injection controller 510 provides the graphic combiner 500 with pre-defined images at a pre-determined insertion time, and the pre-defined images and the insertion time may be determined based on a situation of the video game.

It should be appreciated that the same auxiliary frame may be injected into several consecutive primary frames 540₁ₐ, 540_{1b}, . . . , so as to give the impression of on-screen persistence in the resulting composite frames 550₁ₐ, 550_{1b}, . . . . In still other embodiments, it is envisaged that two or more auxiliary frames may be injected into a single primary frame. For example, instead of combining two images into a single auxiliary frame, two separate auxiliary frames could be created from respective images, and both could be blended with a particular primary frame in order to form the corresponding composite frame.

### Second Embodiment

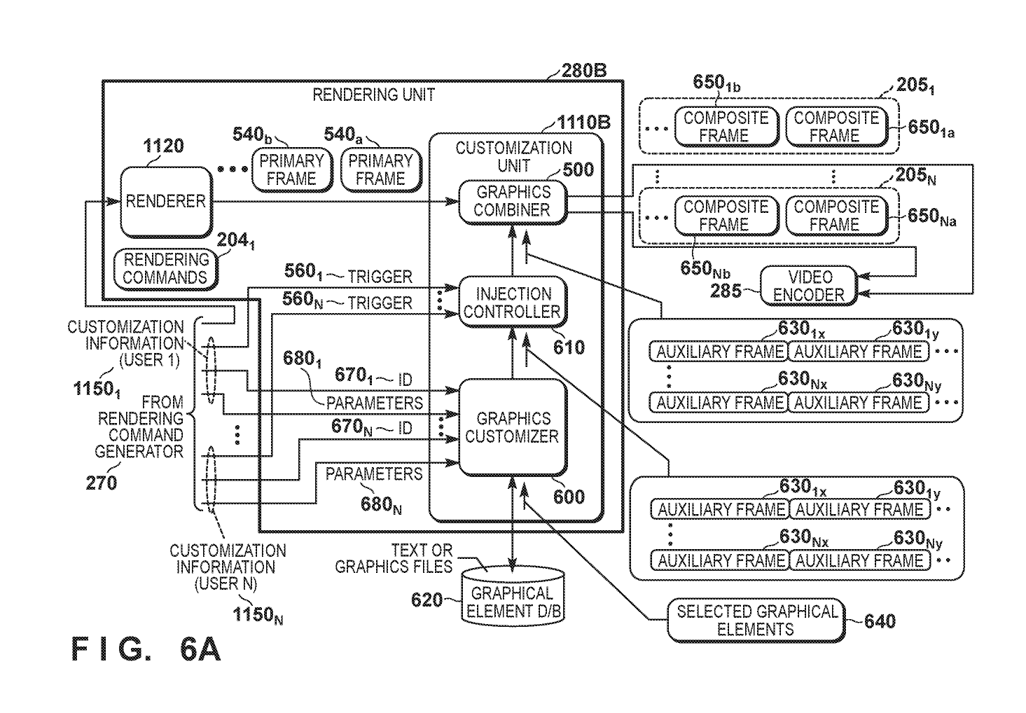

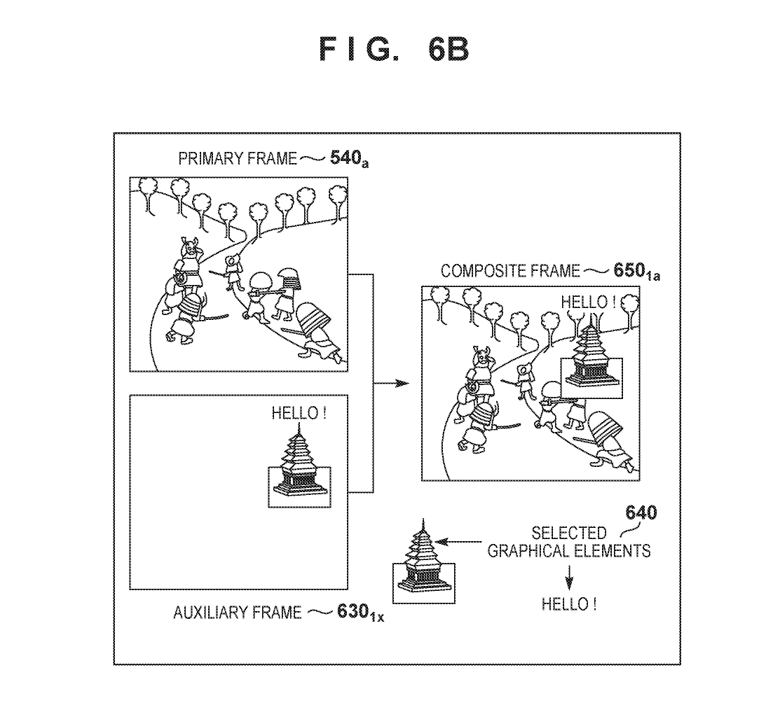

In FIG. 6A, the rendering unit 280 and customization unit 1110 of FIG. 11 are represented as rendering unit 280E and customization unit 1110B, respectively. The customization unit 1110B comprises the aforementioned graphics combiner 500, as well as an injection controller 610 and a graphics customizer 600. The graphics combiner 500 is again disposed along the path between the renderer 1120 and the video encoder 285. As described in the first embodiment, the graphics combiner 500 acquires a primary frame and one or more auxiliary frames for each of users, combines the primary frame and each of the one or more auxiliary frames to form one or more composite frames, each of which is generated for each of a plurality of users (user clients), and outputs the one or more composite frames to the video encoder 285. Each of encoded composite frames is transmitted, via e.g. Internet, to its corresponding user terminal. In addition, also in this embodiment, the composite frames may be generated for not all of the user clients, and the primary frame may be encoded and transmitted to one or more, but not all of the user clients.

Consider the case of video data stream 205₁ containing composite frames 650₁ₐ, 650_{1b}, . . . , for user 1. The graphics combiner 500 creates each of the composite frames 650ₐ₁, 650_{1b}, . . . , by combining a respective one of the primary frames 540ₐ, 540_{b}, . . . with a particular one of the auxiliary frame 630₁ₓ, 630_{1y}, . . . . The primary frames 540ₐ, 540_{b}, . . . , are rendered and supplied by the renderer 1120, whereas the auxiliary frames 630₁ₓ, 630_{1y}, . . . , are supplied by an injection controller 610. It is noted that the auxiliary frames 630₁ₓ, 630_{1y}, . . . , may be supplied by other ways. The graphics combiner 500 blends the auxiliary frames 630₁ₓ, 630_{1y}, . . . , with the primary frames 540ₐ, 540_{b}, . . . , resulting in the composite frames 650₁ₐ, 650_{1b}, . . . . For example, the graphics combiner 500 superimposes the auxiliary frame onto the primary frame. Blending may be achieved using a variety of techniques such as alpha compositing or bit-blitting.

In this embodiment, the injection controller 610 is similar to the injection controller 510 of FIG. 5A. For example, in the case of user 1, one of the similarities is that the injection controller 610 is responsible for supplying the auxiliary frames 630₁ₓ, 630_{1y}, . . . , to the graphics combiner 500 at the appropriate time, based on the aforementioned insertion timing (trigger) signal 560₁ supplied as part of the customization information 1150₁ for user 1. Here, the trigger signal 560₁ may designate a time at which the injection controller 610 provides these auxiliary frames 630₁ₓ, 630_{1y}, . . . to the graphics combiner 500 for injection into the corresponding primary frames 540ₐ, 540_{b}, . . . or at which the graphics combiner 500 combines these auxiliary frames 630₁ₓ, 630_{1y}, . . . with the corresponding primary frames 540ₐ, 540_{b}, . . . . Also in this embodiment, the trigger signal may designate a time in a real world or a time in a virtual world of a video game, in the former case, the injection controller 610 may comprise a real-time clock for identifying the insertion time of the auxiliary frames, and in the latter case, the injection controller 610 may comprise a unit for acquiring a frame number of the video game, for example, a frame counter, so that the injection controller can provide the auxiliary frames to the graphics combiner 500 at the appropriate time. On the other hand, one of the differences is that the auxiliary frames 630₁ₓ, 630_{1y}, . . . , are not supplied directly from an image database, but rather are made available to the injection controller 610 by the graphics customizer 600, which is now described in greater detail.

Specifically, the graphics customizer 600 has access to a graphical element database 620. The graphical element database 620 can store a variety of graphical elements as files, each of which can represent text (e.g., words, messages), graphics (e.g., photos, images) or a combination thereof. Individual graphical elements may be given a unique identifier (ID) so that they can be easily accessed by the graphics customizer 600. The database 620 way be updated dynamically so as to allow the graphical elements stored therein to change.

The graphics customizer 600 carries out two main functions as far as a given user n is concerned (where 1≦n≦N). The first function is to select one or more graphical elements 640 from the graphical element database 620, based on an ID signal 670ₙ forming part of the customization information 1150ₙ for user n, and which is similar to the previously described ID signal 570ₙ. The second function is to transform the selected graphical elements 640 into the auxiliary frames 630ₙₓ, 630_{ny}, . . . , which are supplied to the injection controller 610. This transformation is done on the basis of a set of parameters 680ₙ for user n, which can include a desired size, position or characteristic quality (also referred to as “look and feel”) to be applied to the selected graphical elements 640. The characteristic quality indicates how the graphical elements are presented in the composite frame and may include at least one of font, layout, shape and color. The set of parameters 680ₙ also forms part of the customization information 1150ₙ for user n. It is noted that the set of parameters 680ₙ may change over time. That is, for example, the position, size and/or the characteristic quality to be applied to the graphical elements 640 changes over time. As a result, the graphics customizer 600 generates the auxiliary frames and provides them to the injection controller 610, and the injection controller 610 provides the graphic combiner 500 with the generated auxiliary frames including one or more desired graphical elements, to which the desired characteristic quality is applied, at the desired insertion time.

With additional reference to FIG. 6B, there is shown an example primary frame 540ₐ, two example graphical elements 640, an example auxiliary frame 630₁ₓ and an example composite frame 650₁ₐ. The selected graphical elements 640 contain customized graphical elements (e.g., a text file and a graphics file), in this case for user 1. The selected graphical elements 640 are included in the example auxiliary frame 630₁ₓ, but are appropriately sized, positioned and formatted to yield a screen-size image.

It is noted that in this embodiment, the selected graphical elements 640 can be generic, and may be customized for a given user n based on size, position and/or characteristic quality (i.e., as defined by the set of parameters 680ₙ). That is, the set of parameters 680ₙ may designate a desired size and/or position, at which its corresponding graphical element(s) is placed within a frame, and/or a desired characteristic quality, which indicates how its corresponding graphical element(s) is presented in a composite frame. The set of parameters 680ₙ can be defined for all graphical elements identified by the ID signal 670ₙ, but the set of parameters 680ₙ may be defined for only a part of the graphical elements. The graphic customizer 600 may generate the auxiliary frames by placing the graphical elements at the desired position, size and/or the characteristic quality. The set of parameters 680ₙ can depend on a variety of factors that may be known to the rendering command generator 270. Accordingly, the set of parameters 680ₙ may be supplied by the rendering command generator 270, along with the trigger signal 560ₙ and the ID signal 670ₙ. In a non-limiting example embodiment, the set of parameters 680ₙ may be determined by the rendering command generator 270 based on conducting an analysis of the rendering commands in the set of rendering commands 204₁.

### Third Embodiment

It is recalled that, in the case of user n (1≦n≦N), the set of parameters 680ₙ can represent the position, size and/or characteristic quality (“look and feel”) of the selected graphical elements 640 within the auxiliary frames 630ₙₓ, 640_{ny}, . . . . Since these three examples of parameters depend on the graphical layout of the primary frames 540ₐ, 540_{b}, . . . , it is possible to process the primary frames 540ₐ, 540_{b}, . . . , in order to deduce an appropriate size, position and “look and feel” for the customized text and/or graphics that are to be injected. Such processing of rendered frames can be particularly useful in a case where access to the source code of the video game program at the heart of the rendering command generator 270 is unavailable.

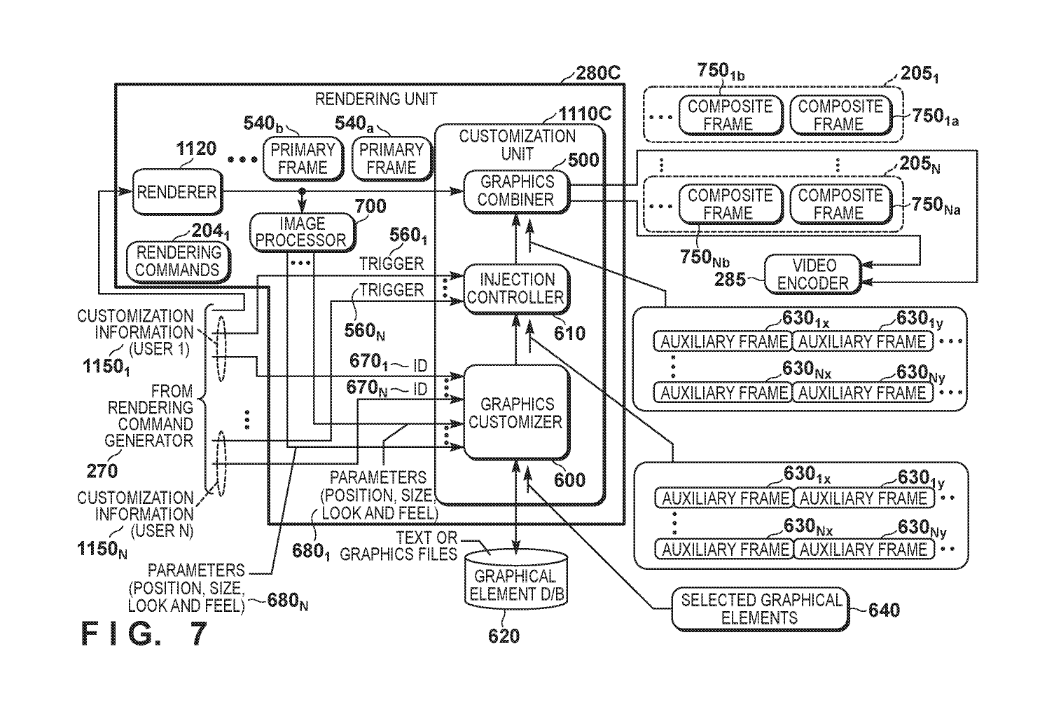

To this end, in FIG. 7, the rendering unit 280 and customization unit 1110 of FIG. 11 are represented as rendering unit 280C and customization unit 1110C, respectively. The rendering unit 280C is substantially similar to the rendering unit 280B of FIG. 6A, except that the customization unit 1110C includes an image processor 700. That is to say, the sets of parameters 680ₙ (1≦n≦N) continue to be supplied to the graphics customizer 600, but they do not originate from the rendering command generator 270. Rather, the sets of parameters 680ₙ (1≦n≦N) are supplied by the image processor 700. Specifically, the image processor 700 receives the primary frames 540ₐ, 540_{b}, . . . , from the renderer 1120 and performs a series of functions (e.g., pattern recognition, text recognition, contrast detection, etc.) in order to identify candidate positions for the graphical elements and/or regions of interest to be avoided. For example, the image processor 700 may analyze the primary frames 540ₐ, 540_{b}, . . . , to extract predefined information about the game (location of the player, current weapon, score, inventory, etc.) then search in a database if the extracted information should trigger a graphic element.

The image processor 700 may also detect various characteristics of the primary frames 540ₐ, 540_{b}, . . . , that can be referred to as the “look and feel”. By way of non-limiting example, the “look and feel” of the primary frames 540ₐ, 540_{b}, . . . , may include a font. A font can automatically be detected using existing utilities such as, e.g., www.myfonts.com/WhatTheFont. Other detectable characteristics can include the size and color of objects (or wording) in the primary frames 540ₐ, 540_{b}, . . . , whose detection can also be automated. However, it is not a requirement for the “look and feel” to be determined in a fully automated fashion. For example, various characteristics pertaining to the “look and feel” of the game could be determined unambiguously by a human, based on objective and repeatable criteria.

The output of the image processor 700 can include the sets of parameters 680ₙ (1≦n≦N), namely a position, size and/or “look and feel” for the selected graphical element(s) 640, which are then used by the graphics customizer 600 as has been previously described. As such, the imago processor 700 may determine the parameters (a desired position, a desired insertion time, and/or a characteristic quality) to be applied to the graphical elements based on a situation of the video game (that is, based on the analysis result of the primary frame).

### Fourth Embodiment

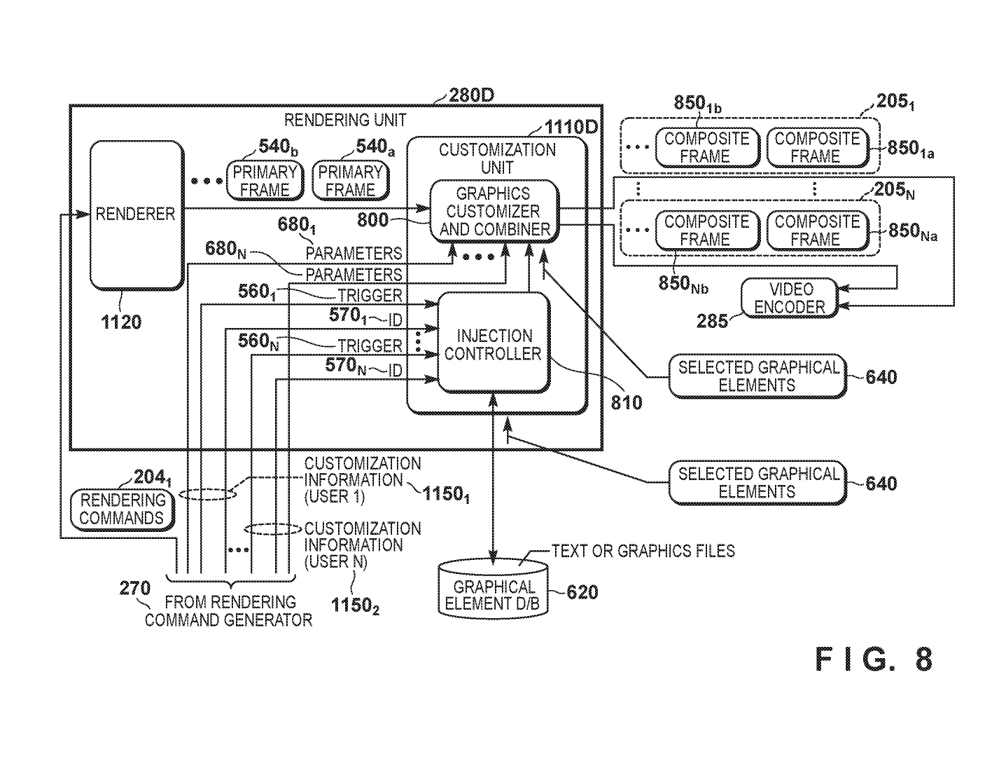

Turning now to FIG. 8, the rendering unit 280 and customization unit 1110 of FIG. 11 are represented as rendering unit 280D and customization unit 1110D, respectively. The customization unit 1110D comprises a graphics customizer and combiner 800, which combines the functionality of the graphics combiner 500 of FIGS. 5A and 6A, and of the graphics customizer 600 of FIG. 6A. The graphics customizer and combiner 800 is disposed along the path between the renderer 1120 and the video encoder 255. In this embodiment, what is supplied to the graphics customizer and combiner 800 is not an auxiliary frame (as was the case in FIGS. 5A and 6A), but rather the selected graphical elements 640 and the aforementioned set of parameters 680₁, . . . , 680ₙ. Specifically, the graphics customizer and combiner 800 performs sizing, positioning and/or formatting of the selected graphical elements 640 for user n according to the set of parameters 680ₙ. The result can be an internally generated auxiliary frame (not shown) which is composited with the primary frames 540ₐ, 540_{b}, . . . , to create composite frames 850ₙₐ, 850_{nb}, . . . , that are sent to the video encoder 285.

In this embodiment, the selected graphical elements 640 are provided by an injection controller 810, which has access to the aforementioned graphical element database 620. In order to extract the appropriate graphical elements from the graphical element database 620 and to supply them to the graphics customizer and combiner 800 at the appropriate time, the injection controller 810 relies on the aforementioned insertion timing (trigger) signals 560₁, . . . , 560_{N} and the aforementioned ID signals 670₁, . . . , 670_{N}. The ID signals 670₁, . . . , 670_{N} identify which graphical elements are the correct ones to retrieve from the database 620 as the selected graphical elements 640. For their part, as already described, the trigger signals 560₁, . . . , 560_{N} designate a time at which the selected graphical elements 640 are to be provided to the graphics customizer and combiner 800 for injection into the primary frames 540ₐ, 540_{b}, . . . or at which the graphics customizer and combiner 800 combines these graphical elements 640 with the primary frames 540ₐ, 540_{b}, . . . . Here, the trigger signal may designate a time in a real world or a time in a virtual world of a video game. In the former case, the injection controller 810 may comprise a real-time clock for identifying the insertion time of the selected graphical elements 640. In the latter case, the injection controller 810 may comprise a unit for acquiring a frame number of the video game, for example, a frame counter, so that the injection controller can provide the selected graphical elements 640 to the graphics customizer and combiner 800 at the appropriate time. In this case, the primary frame 540 may be input to the injection controller 810 for counting up the frame number, or the injection controller 810 may obtain the frame number being counted up at the graphics customizer and combiner 800. The injection controller 810 may acquire information indicating the time of the virtual world of the video game other than the frame number.

It is noted that identification of the appropriate graphical elements (using the ID signal 670ₙ for user n) can depend on a variety of factors, such as the user's identity, demographic information, socio-economic status, geographic location, etc. Also, there may be times during gameplay when it is more desirable (or less desirable) for the selected graphical elements 640 to be injected into the primary frames 540ₐ, 540_{b}, . . . , and this is controlled by the trigger signal 560ₙ. As such, the trigger signal 560ₙ for user n indicates the appropriate moment(s) at which to supply the selected graphical elements 640 to the graphics customizer and combiner 800. The ID signal 670ₙ and the trigger signal 560ₙ may be controlled and supplied by the rendering command generator 270, which may be executed by the compute server 200C.

The graphics customizer and combiner 800 performs two main functions. The first is to transform the selected graphical elements 640 into internal auxiliary frames (not shown). This transformation is done for user n (1≦n≦N) on the basis of the set of parameters 680ₙ, which can include a desired size, position or “look and feel” (characteristic quality) to be applied to the selected graphical elements 640. Here, it is unnecessary for the graphics customizer and combiner 800 to generate the internal auxiliary frames. For example, the graphics customizer and combiner 800 may determine the position, size and/or characteristic quality to be applied to graphical elements, and directly place these graphical elements onto the primary frame in accordance with the determined position, size and/or characteristic quality. The second function of the graphics customizer and combiner 800 is to blend these internal auxiliary frames with the primary frames 540ₐ, 540_{b}, . . . , in order to produce the composite frame 850ₙₐ, 850_{nb}, . . . .

It is noted that in this embodiment, the selected graphical elements 640 are customizable for user n independently of their size, position and “look and feel” (i.e., the set of parameters 680ₙ). The set of parameters 680ₙ can depend on a variety of factors that may be known to the rendering command generator 270. Accordingly, the set of parameters 680ₙ for user n (1≦n≦N), along with the trigger signal 560ₙ and the ID signal 670ₙ, may be supplied by the rendering command generator 270.

### Fifth Embodiment

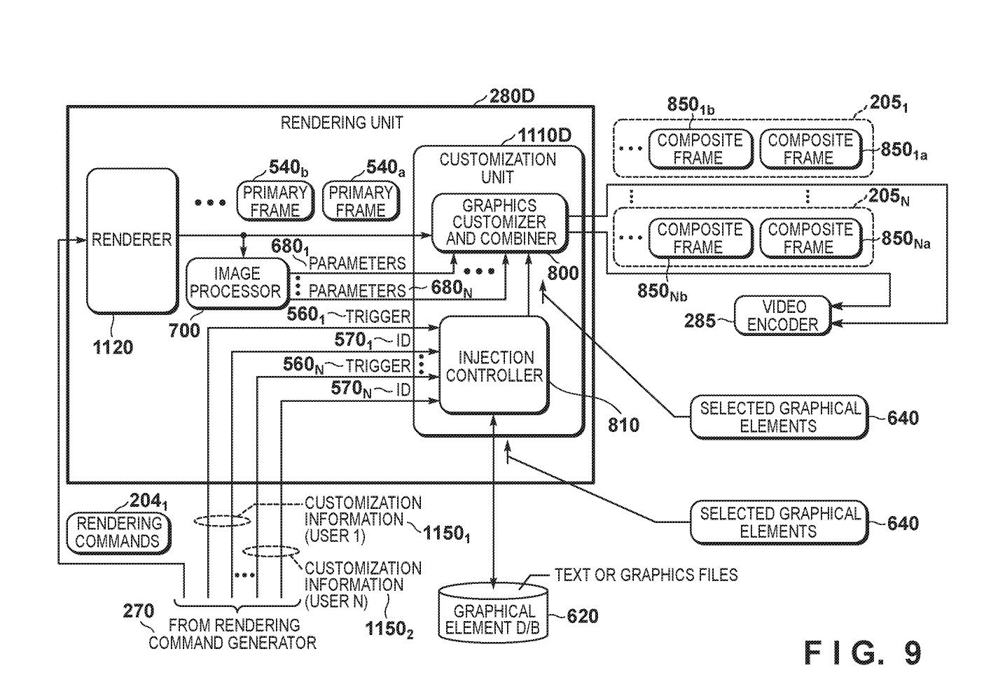

Turning now to FIG. 9, the rendering unit 280 and customization unit 1110 of FIG. 11 are represented as rendering unit 280E and customization unit 1110E, respectively. In this embodiment, the customization unit 1110E includes the aforementioned image processor 700, which has been previously described in the context of FIG. 7. That is to say, set of parameters 680₁, . . . , 680_{N} (which continues to be supplied to the graphics customizer and combiner 800) is not provided by the rendering command generator 270, but rather by the image processor 700. The image processor 700 receives the primary frames 540ₐ, 540_{b}, . . . , and performs a series of functions (e.g., pattern recognition, text recognition, contrast detection, etc.) in order to identify candidate positions for the graphical elements and/or regions of interest to be avoided. The image processor 700 also detects various characteristics of the primary frames 540ₐ, 540_{b}, . . . , that can be referred to as the “look and feel”, in a manner as has already been described. The output of the image processor 700 can include the set of parameters 680₁, . . . 680_{N}, such as a position, size and/or “look and feel” for the selected graphical elements 640 on a per-user basis. As such, the image processor 700 may determine the parameters (a desired position, a desired insertion time, and/or a characteristic quality) to be applied to the graphical elements based on a situation of the video game (that is, based on the analysis result of the primary frame).

### Other Embodiments

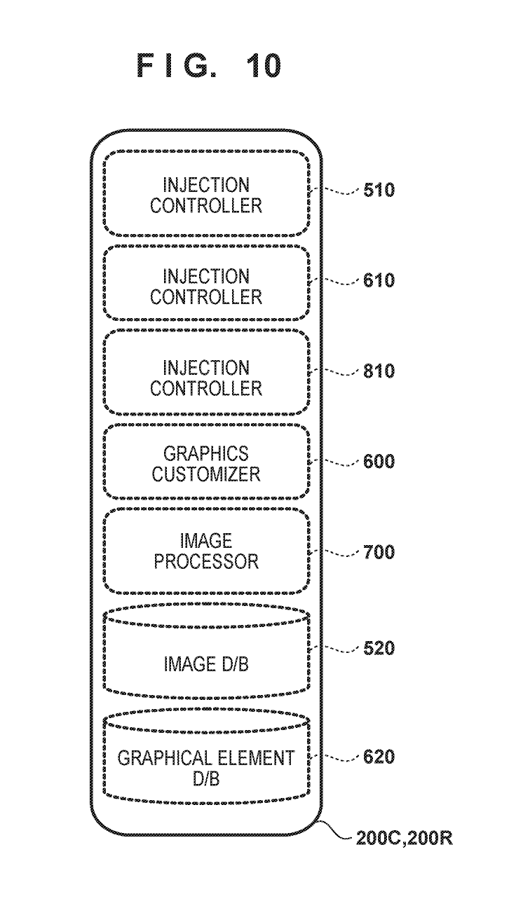

The above Figures show elements that could be implemented as software modules whose functionality is encoded as instructions stored on a computer-readable medium. In the case of the graphic combiner 500 and the graphics customizer and combiner 800, these elements may be implemented as part of the rendering server 200R. In the case of the injection controller 510, 610, 810, the graphics customizer 600, the image processor 700, the graphics customizer and combiner 800, the image database 520 and the graphical element database 620, FIG. 10 illustrates that, in accordance with different embodiments, certain ones of the aforementioned elements may be implemented as part of the compute server 200C or as part of the rendering server 200R. In other embodiments, they may be implemented on separate servers reachable over a network such as the Internet 130.

In accordance with a variant, the image processor 700 can, in addition to the ID signals 570₁, . . . , 570_{N}, 670₁, . . . , 670_{N}, also output the trigger signals 560₁, . . . , 560_{N}, 660₁, . . . , 660_{N}, which indicates when it is appropriate to inject graphics into the primary frames 540ₐ, 540_{b}, . . . . For example, the image processor 700 can detect moments in the game when the action has subsided or there is a transition to a different scene or level. For instance, the screen may become blurry and/or turn to grayscale when the player's character is injured, and it slowly may return to normal as the character recovers, takes cover or flees danger. Such transitions or changes could be defined in terms of a list of elements to be monitored by the image processor 700, thus facilitating the automated detection in the level of action or scene transitions.

Persons skilled in the art should appreciate that the above-discussed embodiments are to be considered illustrative and not restrictive. Also it should be appreciated that additional elements that may be needed for operation of certain embodiments of the present invention may not have been described or illustrated, as they are assumed to be within the purview of the person of ordinary skill in the art. Moreover, certain embodiments of the present invention may be free of, may lack and/or may function without any element that is not specifically disclosed heroin.

Those skilled in the art will also appreciate that additional adaptations and modifications of the described embodiments can be made. The scope of the invention, therefore, is not to be limited by the above description of specific embodiments but rather is defined by the claims attached hereto.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. Also, the image processing apparatus and the method of controlling an information processing apparatus according to the present invention are realizable by a program executing the methods on a computer. The program is providable/distributable by being stored on a computer-readable storage medium or through an electronic communication line.

1-24. (canceled)

25. An image processing apparatus, comprising:
an acquisition unit configured to acquire a first frame, which is rendered by a rendering unit and is included in a video data stream, and acquire additional image data for at least one of a first user or a second user;
a combining unit configured to generate a first composite frame for the first user by combining the first frame and the additional image data for the first user and/or a second composite frame for the second user by combining the first frame and the additional image data for the second user; and
an outputting unit configured to output, for the first user, the first composite frame if the first composite frame is generated or the first frame otherwise, and output, for the second user, the second composite frame if the second composite frame is generated or the first frame otherwise.

26. The apparatus according to claim 25, wherein the acquisition unit is configured to acquire the additional image data from a storage unit.

27. The apparatus according to claim 25, wherein the additional image data is a second frame containing one or more pre-positioned graphical elements.

28. The apparatus according to claim 25, further comprising an accepting unit configured to accept customization information for each user,
wherein the acquisition unit is configured to acquire the additional image data according to the accepted customization information.

29. The apparatus according to claim 28, the customization information for a user comprises at least one of an identifier of the additional image data for the user or information regarding an insertion time of the additional image data.

30. The apparatus according to claim 29, wherein the video data stream relates to a video game, and wherein the identifier of the additional image data is determined based on a situation of the video game.

31. The apparatus according to claim 29, wherein the information regarding the insertion time designates a time at which the additional image data is combined with the first frame or at which the additional image data is acquired by the acquisition unit.

32. The apparatus according to claim 29, wherein the video data stream relates to a video game, and wherein the insertion time is determined based on a situation of the video game.

33. The apparatus according to claim 25, wherein the acquisition unit is configured to acquire one or more graphical elements as the additional image data, and wherein the combining unit is configured to generate a composite frame by placing each of the one or more graphical elements within the first frame.

34. The apparatus according to claim 33, wherein the combining unit is configured to control a position and/or a size at which each of the one or more graphical elements is placed within the first frame.

35. The apparatus according to claim 34, wherein the combining unit is configured to receive a parameter set designating a desired position and/or size at which at least one of the one or more graphical elements is placed within the first frame and to control the position and/or the size at which each of the one or more graphical elements is placed within the first frame in accordance with the desired position and/or size.

36. The apparatus according to claim 34, wherein the position and/or the size at which each of the one or more graphical elements is placed within the first frame changes over time.

37. The apparatus according to claim 35, wherein the parameter set further designates a characteristic quality of at least one of the one or more graphical elements, which indicates how the at least one of the one or more graphical elements is presented in the composite frame.

38. The apparatus according to claim 37, wherein the characteristic quality includes at least one of font, layout, shape and color.

39. The apparatus according to claim 33, further comprising an accepting unit configured to accept customization information for each user,
wherein the acquisition unit is configured to acquire the one or more graphical elements according to the accepted customization information.

40. The apparatus according to claim 35, wherein the combining unit is configured to receive the parameter set as a part of a rendering command set, based on which the rendering unit renders the first frame.

41. The apparatus according to claim 35, further comprising parameter generation unit configured to generate the parameter set by analyzing the first frame.

42. An image processing system, comprising an image processing apparatus and a rendering unit configured to render a first frame, wherein the image processing apparatus comprises:
an acquisition unit configured to acquire a first frame, which is rendered by the rendering unit and is included in a video data stream, and acquire additional image data for at least one of a first user or a second user;
a combining unit configured to generate a first composite frame for the first user by combining the first frame and the additional image data for the first user and/or a second composite frame for the second user by combining the first frame and the additional image data for the second user; and
an outputting unit configured to output, for the first user, the first composite frame if the first composite frame is generated or the first frame otherwise, and output, for the second user, the second composite frame if the second composite frame is generated or the first frame otherwise.

43. A method of processing an image, comprising:
acquiring a first frame, which is rendered by a rendering unit and is included in a video data stream;
acquiring additional image data for at least one of a first user or a second user;
generating a first composite frame for the first user by combining the first frame and the additional image data for the first user and/or a second composite frame for the second user by combining the first frame and the additional image data for the second user;
outputting, for the first user, the first composite frame if the first composite frame is generated or the first frame otherwise; and
outputting, for the second user, the second composite frame if the second composite frame is generated or the first frame otherwise.

44. A non-transitory computer-readable storage medium comprising computer-readable instructions which, when executed by a computing entity, cause the computing entity to implement a method that comprises:
acquiring a first frame, which is rendered by a rendering unit and is included in a video data stream;
acquiring additional image data for at least one of a first user or a second user;
generating a first composite frame for the first user by combining the first frame and the additional image data for the first user and/or a second composite frame for the second user by combining the first frame and the additional image data for the second user;
outputting, for the first user, the first composite frame if the first composite frame is generated or the first frame otherwise; and
outputting, for the second user, the second composite frame if the second composite frame is generated or the first frame otherwise.

45. An image processing apparatus, comprising:
a rendering unit configured to render a set of initial frames representing a sequence of images; and
a customization unit configured to receive customization information for each of a plurality of users and modify the set of initial frames to produce a plurality of sets of output frames, wherein each set of output frames representing a sequence of images that have been customized for a respective one of the users based on the customization information for that user.

46. An image processing systems, comprising an image processing apparatus and a rendering command generation unit configured to generate rendering commands, wherein the image processing apparatus comprises: a rendering unit configured to render a set of initial frames representing a sequence of images; and a customization unit configured to receive customization information for each of a plurality of users and modify the set of initial frames to produce a plurality of sets of output frames, wherein each set of output frames representing a sequence of images that have been customized for a respective one of the users based on the customization information for that user, and
wherein the rendering unit is configured to render the set of initial frames in accordance with the rendering commands.

47. A method of processing an image, comprising:
rendering a set of initial frames representing a sequence of images;
receiving customization information for each of a plurality of users; and
modifying the set of initial frames to produce a plurality of sets of output frames, wherein each set of output frames representing a sequence of images that have been customized for a respective one of the users based on the customization information for that user.

48. A non-transitory computer-readable storage medium comprising computer-readable instructions which, when executed by a computing entity, cause the computing entity to implement a method that comprises:
rendering a set of initial frames representing a sequence of images;
receiving customization information for each of a plurality of users; and
modifying the set of initial frames to produce a plurality of sets of output frames, wherein each set of output frames representing a sequence of images that have been customized for a respective one of the users based on the customization information for that user.
